(19) United States
(12) Patent Application Publication
(10) Pub. No.: US 2026/0003680 A1
(43) Pub. Date: Jan. 1, 2026

(54) ALLOCATING APPARATUS AND ALLOCATION METHOD

(71) Applicant: Hitachi Vantara, Ltd., Yokohama-shi (JP)

(72) Inventors: Shoichiro SUGIYAMA, Yokohama-shi (JP); Masanori FUJII, Yokohama-shi (JP); Kengo MORIYASU, Yokohama-shi (JP)

(21) Appl. No.: 19/081,232

(22) Filed: Mar. 17, 2025

(30) Foreign Application Priority Data
Jul. 1, 2024 (JP) 2024-106436

(51) Int. Cl. G06F 9/50

(52) U.S. Cl. CPC G06F 9/5016; G06F 9/5038; G06F 9/5083

(57) ABSTRACT

A first data mapping table is specified such that each chunk in a first chunk group in each first arrangement group including the first chunk group is distributedly arranged in a different computer node, a second data mapping table is specified such that each chunk in a second chunk group in each second arrangement group including the second chunk group is distributedly arranged in a different computer node, and processor configured to determine whether an imbalance in unallocated capacity among the plurality of computer nodes is within a tolerance, allocate first chunk groups to unallocated capacity of computer node groups with use of the first data mapping table, for when the imbalance is outside the tolerance, and allocate second chunk groups to unallocated capacity of the plurality of computer nodes with use of the second data mapping table, for when the imbalance is within the tolerance.

### CLAIM OF PRIORITY

The present application claims priority from Japanese patent application No. 2024-106436 filed on Jul. 1, 2024, the content of which is hereby incorporated by reference into this application.

### BACKGROUND OF THE INVENTION

### 1. Field of the Invention

The present invention relates to an allocating apparatus that allocates capacity and an allocation method of allocating capacity.

### 2. Description of the Related Art

JP-2020-107082-A discloses a storage system that performs inter-node movement of parities and reconfiguration of stripes in a case where a node configuration is changed. This storage system is a storage system including a plurality of nodes, and the nodes are targets of data write and read requests. Stripes are formed from a plurality of pieces of data stored on different nodes and parities generated on the basis of the plurality of pieces of data, and parities of stripes to which write-requested data belongs are made redundant by storing them on nodes different from the plurality of nodes storing the plurality of pieces of data. In a case where the node configuration is changed, a managing section transmits, to nodes, an arrangement change request for performing inter-node movement of parities and reconfiguration of stripes.

### SUMMARY OF THE INVENTION

Since chunk groups are configured using only a data mapping table that is determined depending on the number of computer nodes in the conventional technology described above, chunk groups can be formed only to make capacity uniform among the computer nodes. That is, in a case where there is an imbalance in capacity (the numbers of chunks) among the computer nodes, remaining capacity of nodes having large capacity becomes large.

An object of the present invention is to reduce an imbalance in capacity among computer nodes.

An allocating apparatus according to an aspect of the invention disclosed in the present application is an allocating apparatus including a processor that executes a program and a storage device that stores the program, in which the storage device stores a first data mapping table and a second data mapping table, the first data mapping table is specified such that each chunk in a first chunk group in each first arrangement group including the first chunk group is distributedly arranged in a different computer node, the number of the first arrangement groups being equal to or greater than two and being equal to the number of a plurality of computer nodes minus one, the second data mapping table is specified such that each chunk in a second chunk group in each second arrangement group including the second chunk group is distributedly arranged in a different computer node, the number of the second arrangement groups being equal to the number of the plurality of computer nodes, and the processor is configured to execute a determination process of determining whether or not an imbalance in unallocated capacity among the plurality of computer nodes to which the chunks are not allocated is within a tolerance range, in a case where the imbalance is determined as being outside the tolerance range in the determination process, a first allocation process of allocating the first chunk groups to unallocated capacity of computer node groups the number of which is equal to the number of the plurality of computer nodes minus one, such that each chunk in the first chunk group in each first arrangement group is distributed to a different computer node, with use of the first data mapping table, and, in a case where the imbalance is determined as being within the tolerance range in the determination process, a second allocation process of allocating the second chunk groups to unallocated capacity of the plurality of computer nodes such that each chunk in the second chunk group in each second arrangement group is distributed to a different computer node, with use of the second data mapping table.

Representative embodiments of the present invention can reduce an imbalance in capacity among computer nodes. Problems, configurations and advantages other than those described above will be made clear by the following explanation of embodiments.

### BRIEF DESCRIPTION OF THE DRAWINGS

FIG. 1 is an explanatory diagram depicting a physical configuration example of a storage system;

FIG. 2 is an explanatory diagram depicting an example of information read out from a drive to a memory;

FIG. 3 is an explanatory diagram depicting an example of a node management table;

FIG. 4 is an explanatory diagram depicting an example of a drive management table;

FIG. 5 is an explanatory diagram depicting an example of a data mapping table;

FIG. 6 is an explanatory diagram depicting an example of a first data mapping table;

FIG. 7 is an explanatory diagram depicting an example of a second data mapping table;

FIG. 8 is an explanatory diagram depicting an example of a chunk management table;

FIG. 9 is an explanatory diagram depicting an example of a group mapping management table;

FIG. 10 is an explanatory diagram depicting an example of a chunk group management table;

FIG. 11 is an explanatory diagram depicting an example of a column node correspondence management table;

FIG. 12 is an explanatory diagram depicting a data mapping example 1;

FIG. 13 is an explanatory diagram depicting a data mapping example 2 (first time);

FIG. 14 is an explanatory diagram depicting the data mapping example 2 (second time);

FIG. 15 is an explanatory diagram depicting the data mapping example 2 (third time);

FIG. 16 is an explanatory diagram depicting the data mapping example 2 (fourth time);

FIG. 17 is an explanatory diagram depicting the data mapping example 2 (fifth time);

FIG. 18 is an explanatory diagram depicting the data mapping example 2 (ninth time);

FIG. 19 is an explanatory diagram depicting the data mapping example 2 (thirteenth time);

FIG. 20 is an explanatory diagram depicting the data mapping example 2 (fourteenth to seventeenth times);

FIG. 21 is a flowchart depicting a capacity generation processing procedure example;

FIG. 22 is a flowchart depicting a detailed processing procedure example of a first allocation process (Step S2106);

FIG. 23 is an explanatory diagram depicting a generation example of entries GM1-1 to GM1-5;

FIG. 24 is an explanatory diagram depicting a generation example of entries GM2-1 to GM2-5;

FIG. 25 is an explanatory diagram depicting a generation example of entries GM3-1 to GM3-5;

FIG. 26 is an explanatory diagram depicting a generation example of entries GM4-1 to GM4-5;

FIG. 27 is an explanatory diagram depicting a generation example of entries GM5-1 to GM5-5;

FIG. 28 is an explanatory diagram depicting a generation example of entries GM9-1 to GM9-5;

FIG. 29 is an explanatory diagram depicting a generation example of entries GM13-1 to GM13-5;

FIG. 30 is an explanatory diagram depicting an entry generation example 1 of the chunk group management table;

FIG. 31 is a flowchart depicting a detailed processing procedure example of a second chunk group generation process (Step S2107);

FIG. 32 is an explanatory diagram depicting an entry generation example 2 of the chunk group management table described in Step S3103;

FIG. 33 is an explanatory diagram depicting the entry generation example 2 of the chunk group management table;

FIG. 34 is an explanatory diagram depicting a configuration change (chunk rebalancing) example;

FIG. 35 is an explanatory diagram depicting an arrangement group identification example in a configuration change 1;

FIG. 36 is an explanatory diagram depicting an arrangement group change example in the configuration change 1;

FIG. 37 is an explanatory diagram depicting an update example 1 of the column node correspondence management table in the configuration change 1;

FIG. 38 is an explanatory diagram depicting an update example of the group mapping management table in the configuration change 1;

FIG. 39 is an explanatory diagram depicting an arrangement group change example in a configuration change 2;

FIG. 40 is an explanatory diagram depicting an update example of the group mapping management table in the configuration change 2;

FIG. 41 is an explanatory diagram depicting an update example of the chunk group management table in the configuration change 2;

FIG. 42 is an explanatory diagram depicting an update example of the chunk management table in the configuration change 2;

FIG. 43 is an explanatory diagram depicting an arrangement group change example in a configuration change 3;

FIG. 44 is an explanatory diagram depicting an update example of the group mapping management table in the configuration change 3;

FIG. 45 is an explanatory diagram depicting an update example of the chunk group management table in the configuration change 3;

FIG. 46 is an explanatory diagram depicting an update example of the chunk management table in the configuration change 3;

FIG. 47 is an explanatory diagram depicting an unnecessary arrangement group deletion example regarding a node group configuration;

FIG. 48 is an explanatory diagram depicting an unnecessary arrangement group deletion example regarding a group mapping management table;

FIG. 49 is an explanatory diagram depicting an unnecessary arrangement group deletion example regarding the chunk group management table;

FIG. 50 is an explanatory diagram depicting an unnecessary arrangement group deletion example regarding the chunk management table; and

FIG. 51 is a flowchart depicting a capacity expansion processing procedure example according to a second embodiment.

### DESCRIPTION OF THE PREFERRED EMBODIMENTS

### First Embodiment

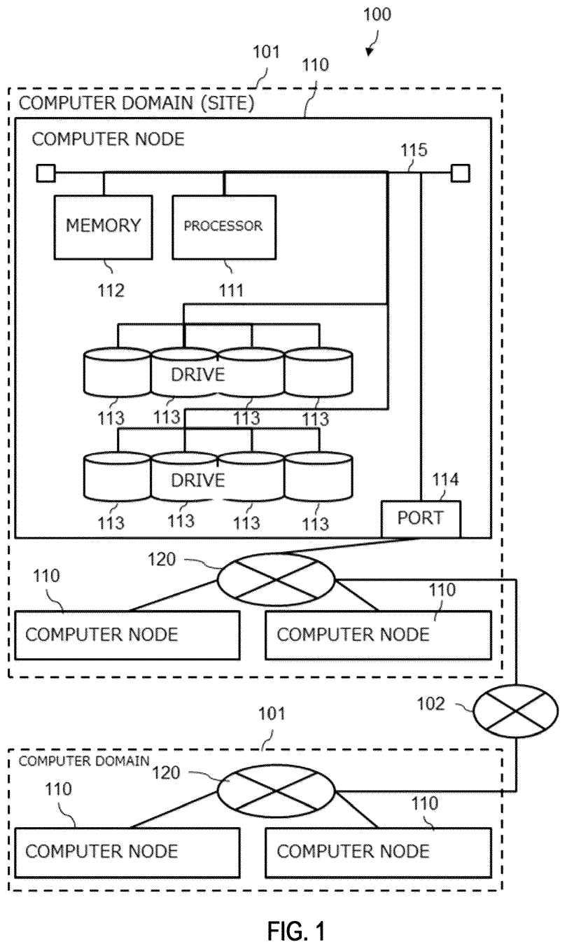

### <FIG. 1: Storage System>

FIG. 1 is an explanatory diagram depicting a physical configuration example of a storage system. A storage system 100 has one or more computer domains 101. The computer domains 101 are communicatively connected to each other via a network 102 such as the Internet, a local area network (LAN), or a wide area network (WAN).

Each computer domain 101 includes one or more computer nodes 110. Each computer node 110 may have a configuration of a typical server computer. For example, the computer node 110 includes a processor 111, a memory 112, one or more drives 113, and one or more ports 114. These constituent elements in the computer node 110 are connected to one another via an internal bus 115.

For example, the processor 111 performs various types of processing. The memory 112 stores information for control required for realizing functions of the computer node 110, stores cached data, and so on. In addition, for example, the memory 112 stores programs executed by the processor 111. The memory 112 may be a volatile dynamic random access memory (DRAM), may be a non-volatile storage class memory (SCM), or may be another storage device.

Each drive 113 stores various types of data, programs, and the like. The drive 113 may be a hard disk drive (HDD) or a solid state drive (SSD) of serial attached small computer system interface (serial attached SCSI, or SAS) or serial advanced technology attachment (SATA) connection, an SSD of non-volatile memory express (NVMe) connection, or a non-volatile memory (SCM).

Each port 114 is connected to a network 120, and is communicatively connected to other computer nodes 110 in the computer domain 101. For example, the network 120 is a LAN, but is not limited to a LAN.

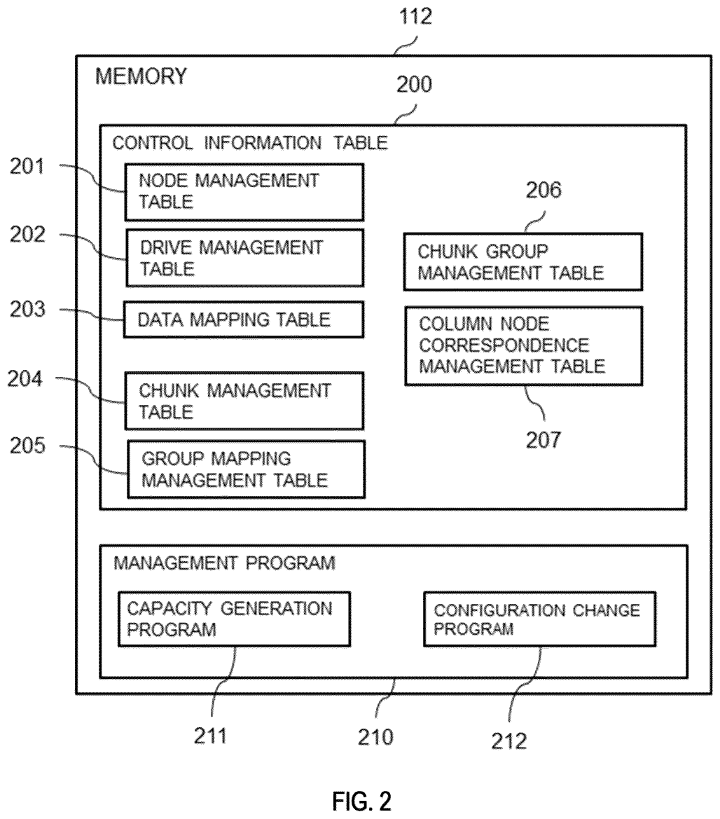

The physical configuration related to the storage system 100 is not limited to the details described above. For example, the networks 102 and 120 may be made redundant. In addition, for example, the network 120 may include a management network and a storage network which are separate from each other, its connection standard may be Ethernet (registered trademark), Infiniband, or a wireless standard, and its connection topology also is not limited to the configuration depicted in FIG. 1.

<FIG. 2: Information Read Out from Drives 113 to Memory 112>

FIG. 2 is an explanatory diagram depicting an example of information read out from the drives 113 to the memory 112. The memory 112 has stored thereon a control information table 200 and a management program 210.

The control information table 200 has a node management table 201, a drive management table 202, a data mapping table 203, a chunk management table 204, a group mapping management table 205, a chunk group management table 206, and a column node correspondence management table 207.

The management program 210 has a capacity generation program 211 and a configuration change program 212.

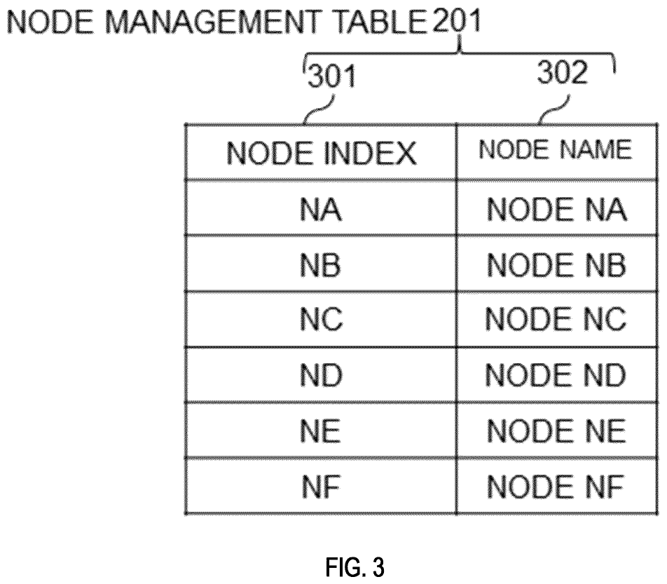

### <FIG. 3: Node Management Table 201>

FIG. 3 is an explanatory diagram depicting an example of the node management table 201. The node management table 201 is a table for managing computer nodes 110. The node management table 201 is a preset table. The node management table 201 has fields of node indices 301 and node names 302. The node indices 301 are identification information uniquely identifying the computer nodes 110. The node names 302 are names “nodes NX” of the computer nodes 110 (X is a capital letter of any alphabet corresponding to each computer node 110). Hereinbelow, the computer nodes 110 are referred to using the node names 302 in some cases.

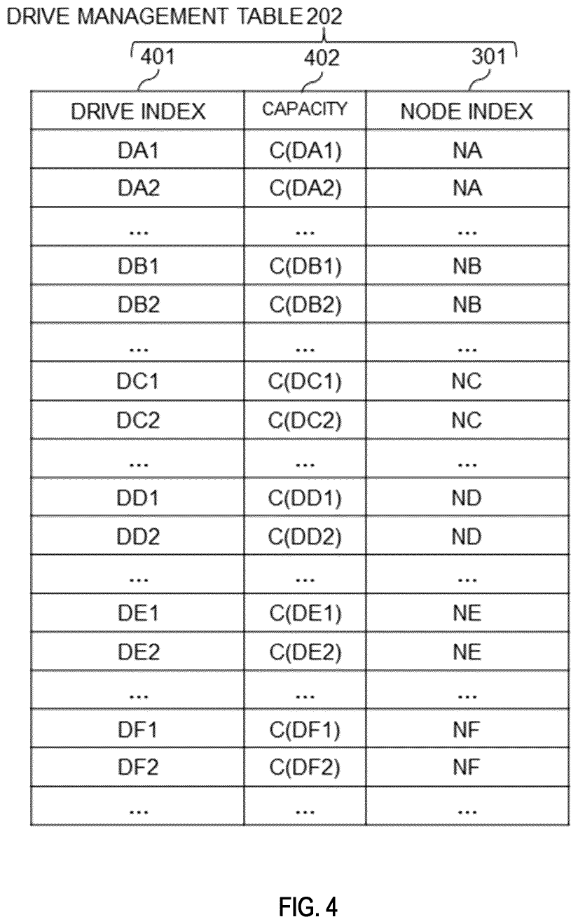

### <FIG. 4: Drive Management Table 202>

FIG. 4 is an explanatory diagram depicting an example of the drive management table 202. The drive management table 202 is a table for managing drives 113. The drive management table 202 is a preset table. The drive management table 202 has fields of drive indices 401, capacity 402, and the node indices 301.

The drive indices 401 are identification information uniquely identifying drives 113 of nodes NX. The drives 113 identified by the drive indices 401 are referred to as drives DX #(# is a number). The capacity 402 is the sizes of data that can be stored on the drives DX #.

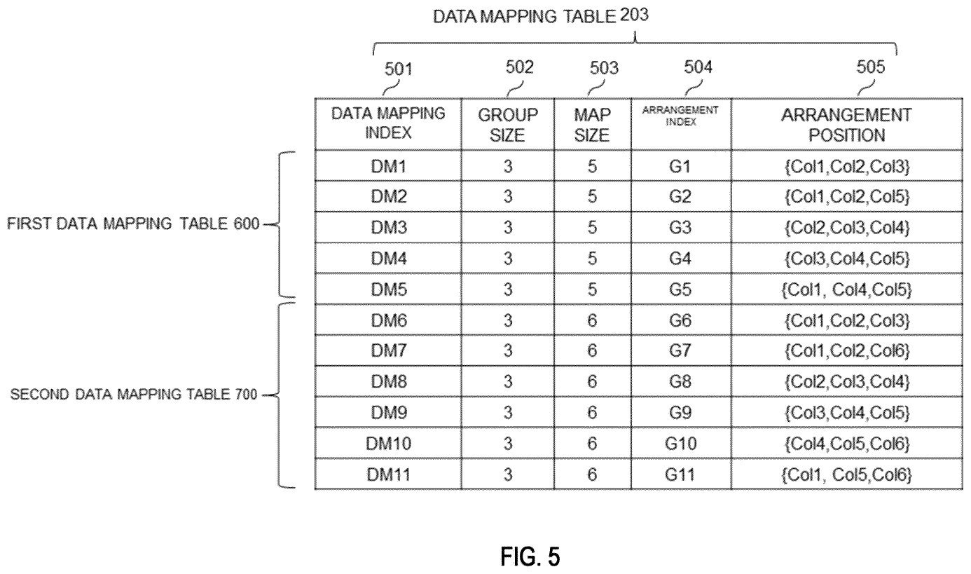

### <FIG. 5: Data Mapping Table 203>

FIG. 5 is an explanatory diagram depicting an example of the data mapping table 203. The data mapping table 203 is a table specifying mappings of arrangement groups to computer nodes 110. The data mapping table 203 is a preset table. Arrangement groups G #(# is a number) are sets of unit physical areas called chunks in drives 113. Each arrangement group G # is configured across one or more computer nodes 110.

The data mapping table 203 is a table optimized according to the number of computer nodes 110 when the arrangement groups G # are formed, and enables distributed arrangement of the arrangement groups G #. Accordingly, in the data mapping table 203, capacity is formed for each data mapping table unit. A data mapping table unit is (n+m chunks)×(the number of computer nodes) in the case of a redundant configuration mD+nP. m and n are integers equal to or greater than one.

In the redundant configuration mD+nP, data is made redundant with use of a combination of the number m of data elements included in the data and the number n of parities of the data. Specifically, for example, the redundant configuration mD+nP means making data redundant at a rate of data elements and parities which is m:n in the arrangement groups G #. The data mapping table 203 is hard-coded for a redundant configuration 2D+1P.

The data mapping table 203 has fields of data mapping indices 501, group sizes 502, map sizes 503, arrangement indices 504, and arrangement positions 505. The data mapping indices 501 are identification information uniquely identifying data mappings of the arrangement groups G #. Hereinbelow, respective entries of the data mapping table 203 are referred to as data mappings DM1, DM2, . . . , and DM11 using the data mapping indices 501, in some cases. In addition, when distinctions are not made among the data mappings DM1, DM2, . . . , and DM11, they are referred to as data mappings DM.

The group sizes 502 are the sizes of the arrangement groups G #, that is, the numbers of computer nodes 110 across which the arrangement groups G # are configured, that is, m+n. Since redundancy is realized using m+n=three computer nodes 110 in the case of the redundant configuration 2D+1P, the group size 502 of each of the data mappings DM1 to DM11 is “3.”

The map sizes 503 are sizes of mapping of the arrangement groups G #, that is, the numbers of columns. Since the arrangement groups G # are distributedly arranged to columns Col1 to Col5 in the case of the present example, the map sizes 503 are “5.”

The arrangement indices 504 are identification information uniquely identifying the arrangement groups G #. The arrangement positions 505 are column positions where the arrangement groups G # are arranged. Each of the columns Col1 to Col5 corresponds to a computer node 110. Note that, when distinctions are not made among Col1 to Col5, they are referred to as Col.

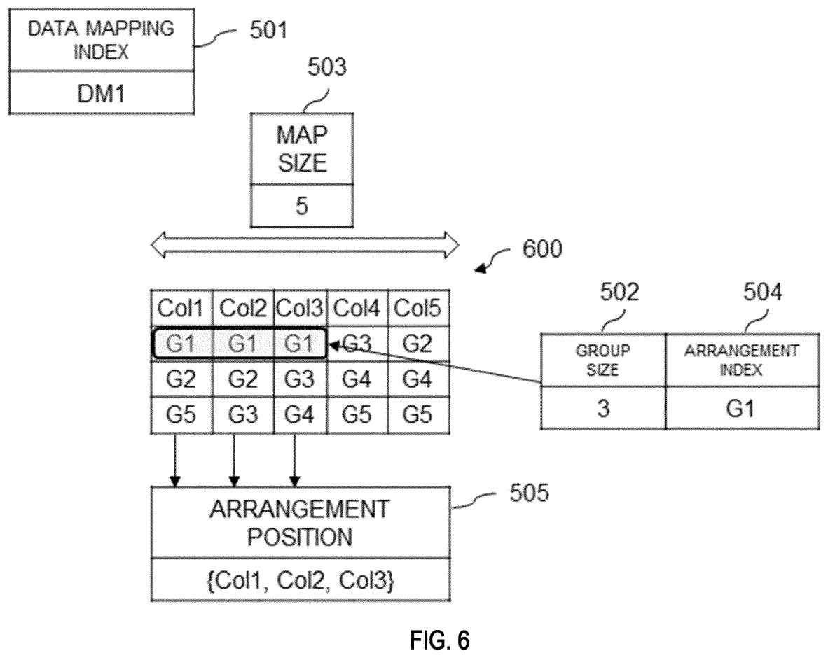

### <FIG. 6: First Data Mapping Table>

FIG. 6 is an explanatory diagram depicting an example of a first data mapping table. A first data mapping table 600 includes the data mappings DM1 to DM5 in the data mapping table 203. Cells that read “G1” to “G5” in the first data mapping table 600 represent chunks.

With attention paid to the arrangement group G1, constituent elements (two data elements and one parity) in the arrangement group G1 are allocated to computer nodes 110 corresponding to Col1, Col2, and Col3, respectively. Accordingly, arrangement positions 505 of the arrangement group G1 are {Col1, Col2, Col3}. That is, this means that “G1” in Col1, “G1” in Col2, and “G1” in Col3 are included in the arrangement group G1. The same applies also to the arrangement groups G2 to G5, but their arrangement positions 505 are different.

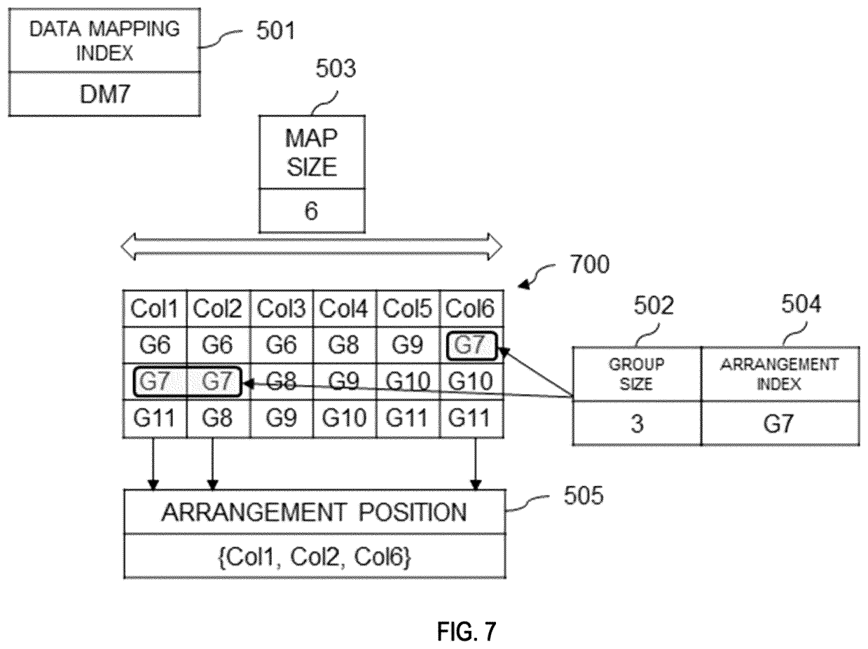

### <FIG. 7: Second Data Mapping Table>

FIG. 7 is an explanatory diagram depicting an example of a second data mapping table. A second data mapping table 700 includes the data mappings DM6 to DM11 in the data mapping table 203. Cells that read “G6” to “G11” in the second data mapping table 700 represent chunks.

With attention paid to the arrangement group G7, constituent elements (two data elements and one parity) in the arrangement group G7 are allocated to computer nodes 110 corresponding to Col1, Col2, and Col6, respectively. Accordingly, arrangement positions 505 of the arrangement group G7 are {Col1, Col2, Col6}. The same applies also to the arrangement groups G7 to G11, but their arrangement positions 505 are different.

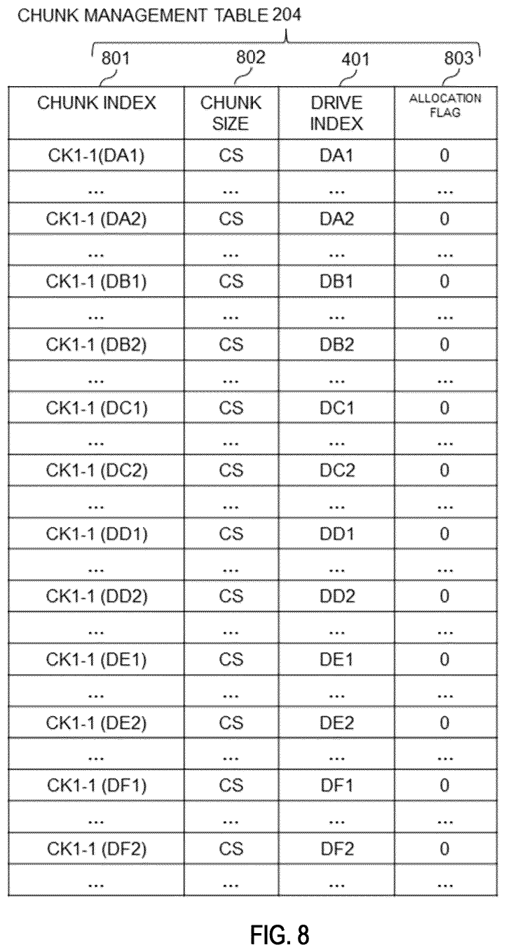

### <FIG. 8: Chunk Management Table 204>

FIG. 8 is an explanatory diagram depicting an example of the chunk management table 204. The chunk management table 204 is a table for managing chunks. The chunk management table 204 is created by execution of the capacity generation program 211. The chunk management table 204 has fields of chunk indices 801, chunk sizes 802, drive indices 401, and allocation flags 803.

The chunk indices 801 are identification information uniquely identifying chunks created in drives DX #. The chunks identified by the chunk indices 801 are referred to as chunks CK #(DX #). The chunk sizes 802 are the sizes (capacity) of the chunks CK #(DX #). Note that, when distinctions are not made among the chunks CK #(DX #), they are referred to as chunks CK (DX). The allocation flags 803 are flags representing whether or not the chunks CK #(DX #) have been allocated. “1” represents that the chunk has been allocated, and “0” represents that the chunk has not been allocated. The allocation flags 803 are “0” by default.

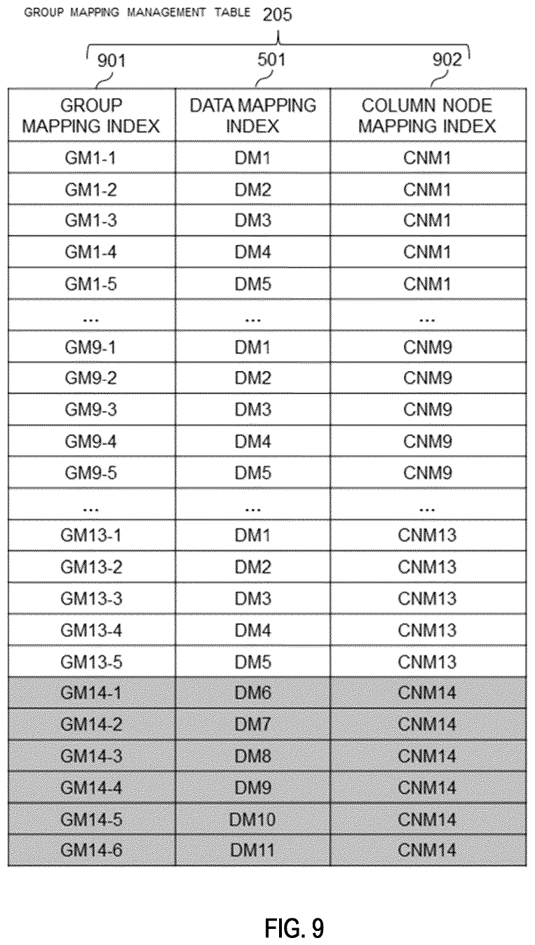

### <FIG. 9: Group Mapping Management Table 205>

FIG. 9 is an explanatory diagram depicting an example of the group mapping management table 205. The group mapping management table 205 is a table for managing group mappings. Group mappings are the correspondence between the data mapping indices 501 and column node mapping indices 902. The group mapping management table 205 is created by execution of the capacity generation program 211.

The group mapping management table 205 has fields of group mapping indices 901, the data mapping indices 501, and the column node mapping indices 902. The group mapping indices 901 are identification information uniquely identifying group mappings GM #. The column node mapping indices 902 are identification information (column node mappings) uniquely identifying the correspondence between columns Col and nodes NX.

The group mappings identified by the group mapping indices 901 are referred to as group mappings GM #. When distinctions are not made among the group mappings GM #, they are referred to as group mappings GM. In addition, entries identified by the group mappings GM # are referred to as entries GM # in some cases.

The column node mappings identified by the column node mapping indices 902 are referred to as column node mappings CNM #. When distinctions are not made among the column node mappings CNM #, they are referred to as column node mappings CNM. In addition, entries identified by the column node mappings CNM # are referred to as entries CNM # in some cases.

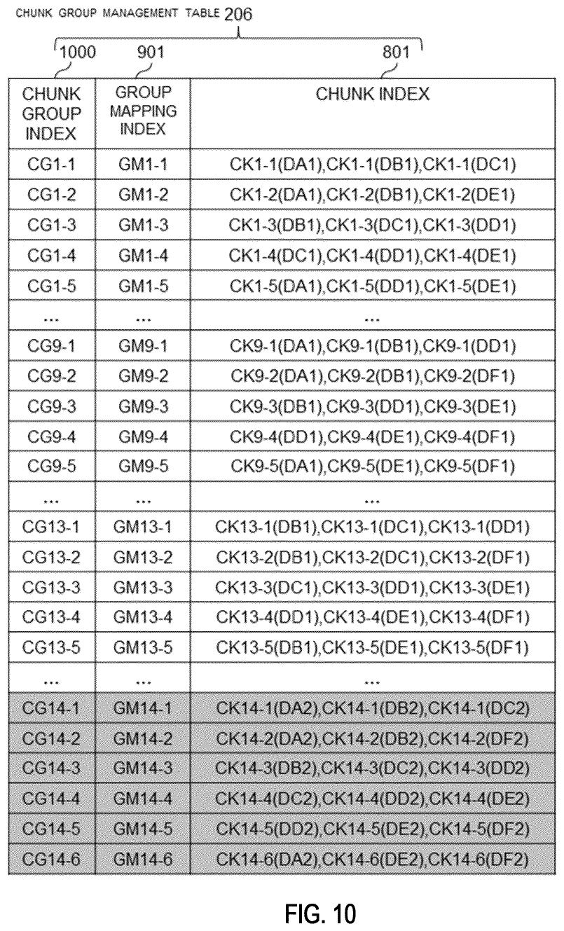

### <FIG. 10: Chunk Group Management Table 206>

FIG. 10 is an explanatory diagram depicting an example of the chunk group management table 206. The chunk group management table 206 is a table for managing chunk groups. Chunk groups are sets of chunks CK (DX) created in the same or different drives 113. The chunk group management table 206 is created by execution of the capacity generation program 211.

The chunk group management table 206 has fields of chunk group indices 1000, the group mapping indices 901, and the chunk indices 801. The chunk group indices 1000 are identification information uniquely identifying chunk groups. The chunk groups identified by the chunk group indices 1000 are referred to as chunk groups CG #. When distinctions are not made among chunk groups CG1 to CG19, they are referred to as chunk groups CG. In addition, entries identified by the chunk groups CG # are referred to as entries CG # in some cases.

Since the chunk group indices 1000 are associated with the group mapping indices 901, the chunk group indices 1000 are associated also with the data mapping indices 501 and the column node mapping indices 902 depicted in FIG. 9.

In addition, since the chunk group indices 1000 are associated also with the chunk indices 801, it is identified which chunks CK (DX) are included in which chunk group CG.

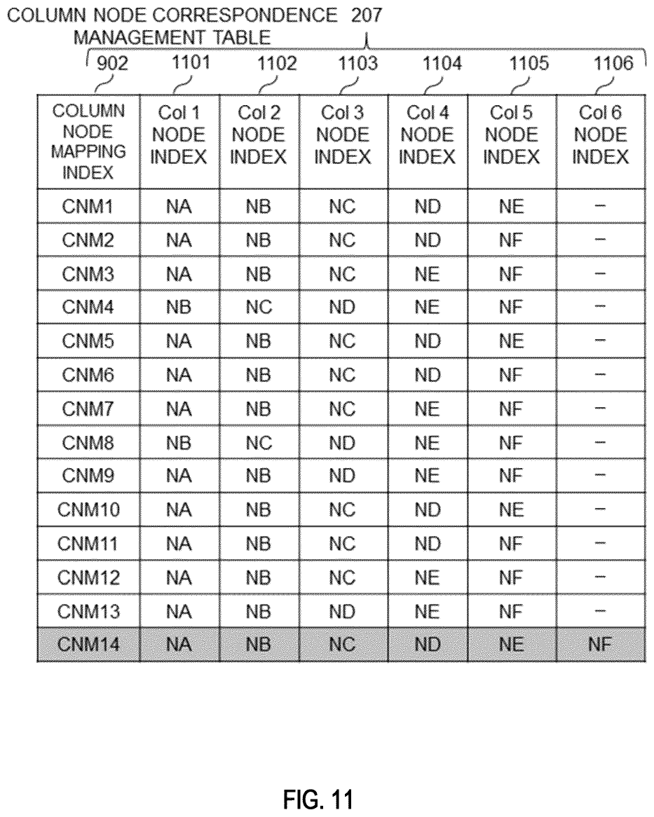

### <FIG. 11: Column Node Correspondence Management Table 207>

FIG. 11 is an explanatory diagram depicting an example of the column node correspondence management table 207. The column node correspondence management table 207 is a table for managing the correspondence between columns Col and nodes NX. The column node correspondence management table 207 is created by execution of the capacity generation program 211.

The column node correspondence management table 207 has fields of the column node mapping indices 902 and Col1 node indices 1101 to Col6 node indices 1106. Each of the Col1 node indices 1101 to the Col6 node indices 1106 identifies a node NX corresponding to the column Col. Since the maximum number of computer nodes 110 used is six in the present example, the number of columns is also six. Accordingly, the Col1 node indices 1101 to the Col6 node indices 1106 change depending on the number of computer nodes 110 used.

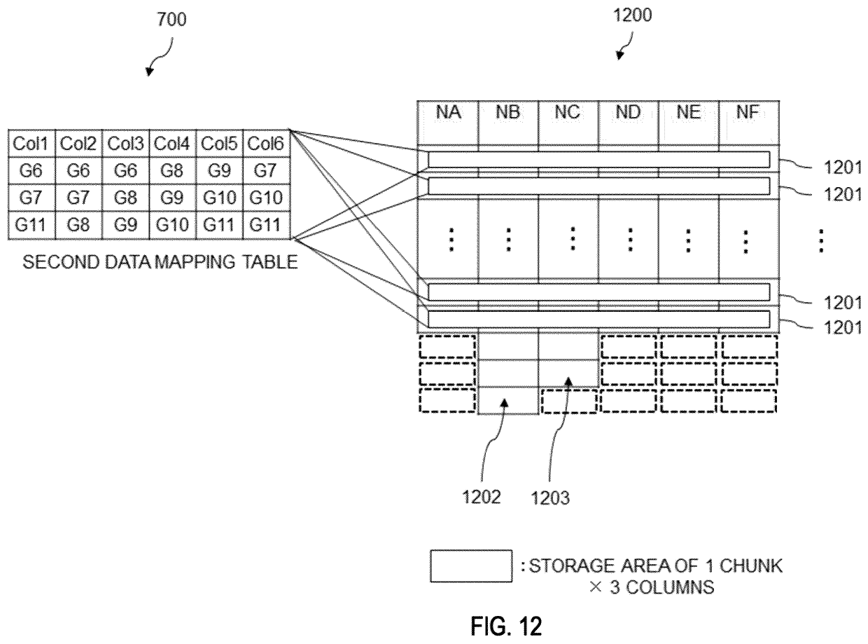

### <FIG. 12: Data Mapping Example 1>

FIG. 12 is an explanatory diagram depicting a data mapping example 1. The data mapping example 1 depicts an example in which the second data mapping table 700 is used to allocate arrangement groups GX to a plurality of computer nodes 110 (nodes NA to NF) that vary in capacity from one another.

A node group configuration 1200 represents the capacity of each of the nodes NA to NF. Each cell of the nodes NA to NF represented by a rectangle represents capacity of three chunks, as an example. In the present example, the number of cells of the node NB is three more than the numbers of cells of the nodes NA and ND to NF, and the number of cells of the node NC is two more than the numbers of cells of the nodes NA and ND to NF.

The second data mapping table 700 is mapped to each cell of cell rows 1201 of the nodes NA to NF in the node group configuration 1200. In this case, the second data mapping table 700 is not mapped to three cells 1202 of the node NB and two cells 1203 of the node NC.

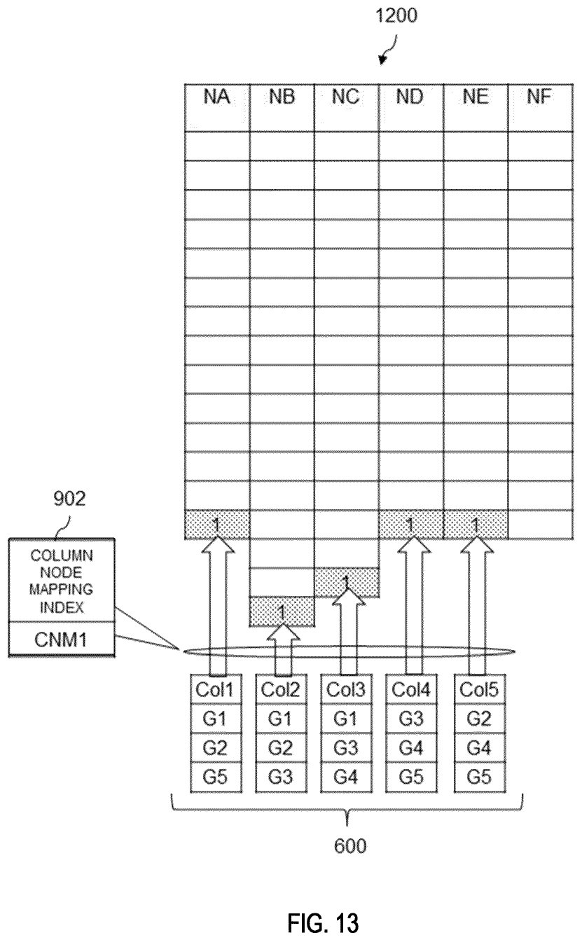

### <FIG. 13 to FIG. 19: Data Mapping Example 2>

Next, an example in which arrangement groups GX are allocated to the node group configuration 1200 with reference to the column node correspondence management table 207 is depicted with use of the first data mapping table 600. Note that, although a column node mapping CNM is referred to in a mapping, the column node mapping CNM to be referred to is selected in accordance with priority criteria described later.

### [FIG. 13: Data Mapping Example 2 (First Time)]

FIG. 13 is an explanatory diagram depicting a data mapping example 2 (first time). In the first data mapping, the arrangement groups G1 to G5 specified in the first data mapping table 600 are mapped to the nodes NA to NE according to a column node mapping CNM1.

Specifically, for example, the respective constituent elements {G1, G2, G5} of the arrangement groups G1, G2, and G5 included in the column Col1 are mapped to the node NA, the respective constituent elements {G1, G2, G3} of the arrangement groups G1 to G3 included in the column Col2 are mapped to the node NB, the respective constituent elements {G1, G3, G4} of the arrangement groups G1, G3, and G4 included in the column Col3 are mapped to the node NC, the respective constituent elements {G3, G4, G5} of the arrangement groups G3 to G5 included in the column Col4 are mapped to the node ND, and the respective constituent elements {G2, G4, G5} of the arrangement groups G2, G4, and G5 included in the column Col5 are mapped to the node NE.

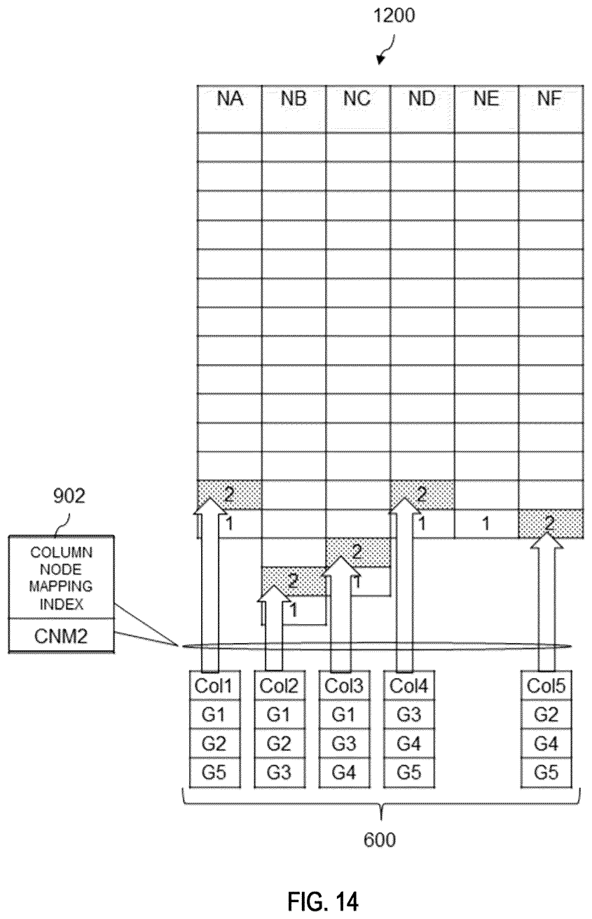

### [FIG. 14: Data Mapping Example 2 (Second Time)]

FIG. 14 is an explanatory diagram depicting the data mapping example 2 (second time). In the second data mapping, the arrangement groups G1 to G5 specified in the first data mapping table 600 are mapped to the nodes NA to ND and NF according to a column node mapping CNM2.

Specifically, for example, the respective constituent elements {G1, G2, G5} of the arrangement groups G1, G2, and G5 included in the column Col1 are mapped to the node NA, the respective constituent elements {G1, G2, G3} of the arrangement groups G1 to G3 included in the column Col2 are mapped to the node NB, the respective constituent elements {G1, G3, G4} of the arrangement groups G1, G3, and G4 included in the column Col3 are mapped to the node NC, the respective constituent elements {G3, G4, G5} of the arrangement groups G3 to G5 included in the column Col4 are mapped to the node ND, and the respective constituent elements {G2, G4, G5} of the arrangement groups G2, G4, and G5 included in the column Col5 are mapped to the node NF.

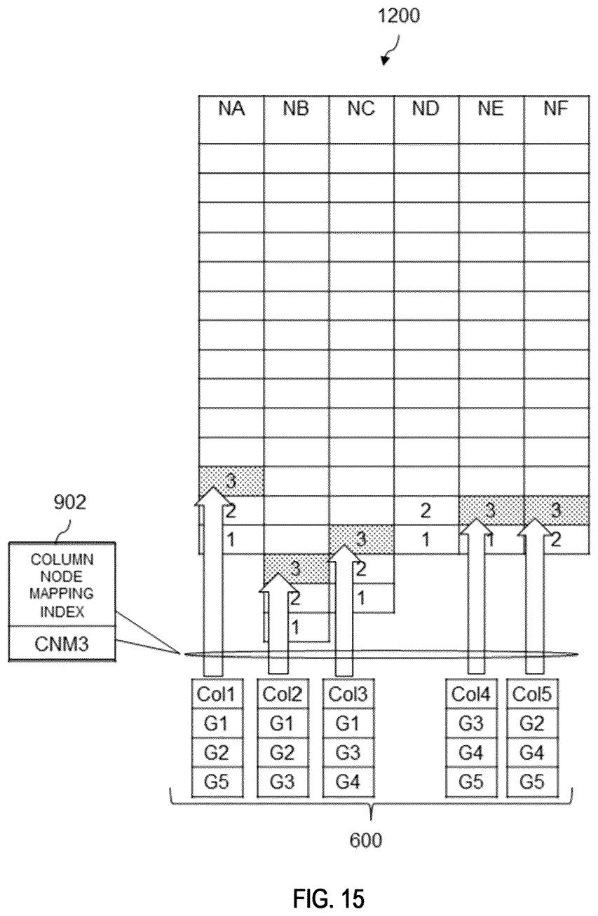

### [FIG. 15: Data Mapping Example 2 (Third Time)]

FIG. 15 is an explanatory diagram depicting the data mapping example 2 (third time). In the third data mapping, the arrangement groups G1 to G5 specified in the first data mapping table 600 are mapped to the nodes NA to NC, NE, and NF according to a column node mapping CNM3.

Specifically, for example, the respective constituent elements {G1, G2, G5} of the arrangement groups G1, G2, and G5 included in the column Col1 are mapped to the node NA, the respective constituent elements {G1, G2, G3} of the arrangement groups G1 to G3 included in the column Col2 are mapped to the node NB, the respective constituent elements {G1, G3, G4} of the arrangement groups G1, G3, and G4 included in the column Col3 are mapped to the node NC, the respective constituent elements {G3, G4, G5} of the arrangement groups G3 to G5 included in the column Col4 are mapped to the node NE, and the respective constituent elements {G2, G4, G5} of the arrangement groups G2, G4, and G5 included in the column Col5 are mapped to the node NF.

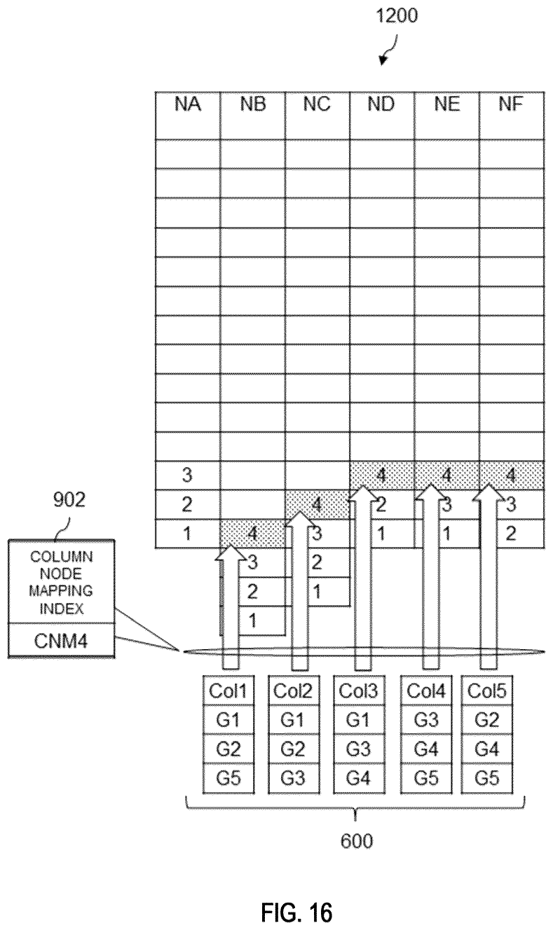

### [FIG. 16: Data Mapping Example 2 (Fourth Time)]

FIG. 16 is an explanatory diagram depicting the data mapping example 2 (fourth time). In the fourth data mapping, the arrangement groups G1 to G5 specified in the first data mapping table 600 are mapped to the nodes NB to NF according to a column node mapping CNM4.

Specifically, for example, the respective constituent elements {G1, G2, G5} of the arrangement groups G1, G2, and G5 included in the column Col1 are mapped to the node NB, the respective constituent elements {G1, G2, G3} of the arrangement groups G1 to G3 included in the column Col2 are mapped to the node NC, the respective constituent elements {G1, G3, G4} of the arrangement groups G1, G3, and G4 included in the column Col3 are mapped to the node ND, the respective constituent elements {G3, G4, G5} of the arrangement groups G3 to G5 included in the column Col4 are mapped to the node NE, and the respective constituent elements {G2, G4, G5} of the arrangement groups G2, G4, and G5 included in the column Col5 are mapped to the node NF.

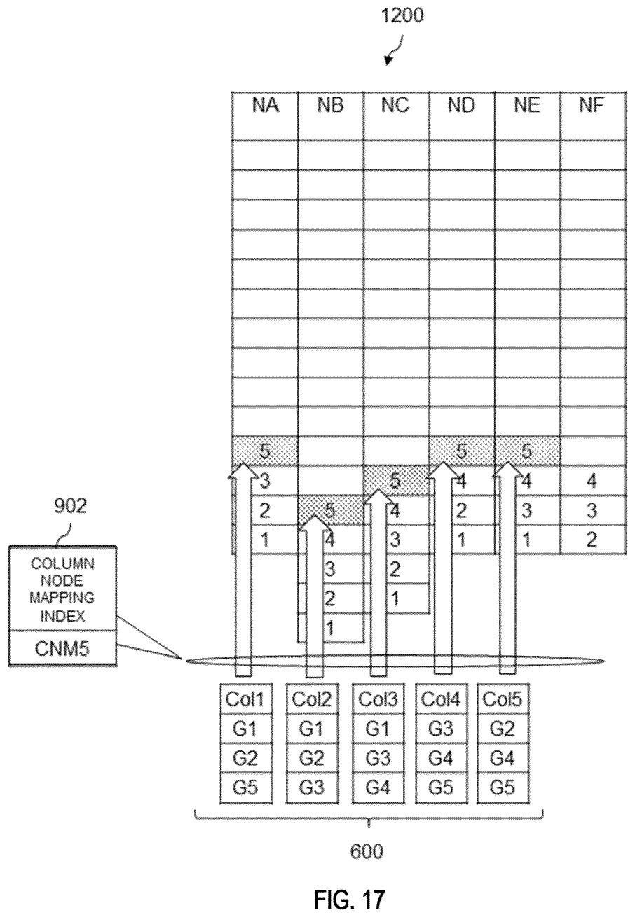

### [FIG. 17: Data Mapping Example 2 (Fifth Time)]

FIG. 17 is an explanatory diagram depicting the data mapping example 2 (fifth time). In the fifth data mapping, the arrangement groups G1 to G5 specified in the first data mapping table 600 are mapped to the nodes NA to NE according to a column node mapping CNM5.

Specifically, for example, the respective constituent elements {G1, G2, G5} of the arrangement groups G1, G2, and G5 included in the column Col1 are mapped to the node NA, the respective constituent elements {G1, G2, G3} of the arrangement groups G1 to G3 included in the column Col2 are mapped to the node NB, the respective constituent elements {G1, G3, G4} of the arrangement groups G1, G3, and G4 included in the column Col3 are mapped to the node NC, the respective constituent elements {G3, G4, G5} of the arrangement groups G3 to G5 included in the column Col4 are mapped to the node ND, and the respective constituent elements {G2, G4, G5} of the arrangement groups G2, G4, and G5 included in the column Col5 are mapped to the node NE.

### [Not Depicted: Data Mapping Example 2 (Sixth Time to Eighth Time)]

Although not depicted, similarly to the data mapping example 2 (second time) depicted in FIG. 14, in the data mapping example 2 (sixth time), the arrangement groups G1 to G5 specified in the first data mapping table 600 are mapped to the nodes NA to ND and NF according to a column node mapping CNM6.

In addition, similarly to the data mapping example 2 (third time) depicted in FIG. 15, in the data mapping example 2 (seventh time), the arrangement groups G1 to G5 specified in the first data mapping table 600 are mapped to the nodes NA to NC, NE, and NF according to a column node mapping CNM7.

In addition, similarly to the data mapping example 2 (fourth time) depicted in FIG. 16, in the data mapping example 2 (eighth time), the arrangement groups G1 to G5 specified in the first data mapping table 600 are mapped to the nodes NB to NF according to a column node mapping CNM8.

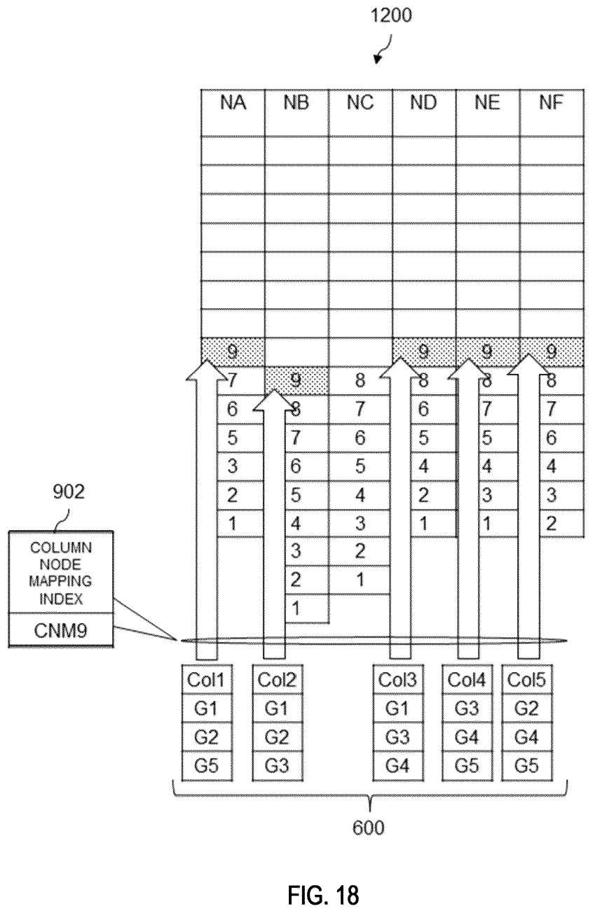

### [FIG. 18: Data Mapping Example 2 (Ninth Time)]

FIG. 18 is an explanatory diagram depicting the data mapping example 2 (ninth time). In the ninth data mapping, the arrangement groups G1 to G5 specified in the first data mapping table 600 are mapped to the nodes NA, NB, and ND to NF according to a column node mapping CNM9.

Specifically, for example, the respective constituent elements {G1, G2, G5} of the arrangement groups G1, G2, and G5 included in the column Col1 are mapped to the node NA, the respective constituent elements {G1, G2, G3} of the arrangement groups G1 to G3 included in the column Col2 are mapped to the node NB, the respective constituent elements {G1, G3, G4} of the arrangement groups G1, G3, and G4 included in the column Col3 are mapped to the node ND, the respective constituent elements {G3, G4, G5} of the arrangement groups G3 to G5 included in the column Col4 are mapped to the node NE, and the respective constituent elements {G2, G4, G5} of the arrangement groups G2, G4, and G5 included in the column Col5 are mapped to the node NF.

### [not Depicted: Data Mapping Example 2 (Tenth Time to Twelfth Time)]

Although not depicted, similarly to the data mapping example 2 (first time) depicted in FIG. 13, in the data mapping example 2 (tenth time), the arrangement groups G1 to G5 specified in the first data mapping table 600 are mapped to the nodes NA to NE according to a column node mapping CNM10.

In addition, similarly to the data mapping example 2 (second time) depicted in FIG. 14, in the data mapping example 2 (eleventh time), the arrangement groups G1 to G5 specified in the first data mapping table 600 are mapped to the nodes NA to ND and NF according to a column node mapping CNM11.

In addition, similarly to the data mapping example 2 (third time) depicted in FIG. 15, in the data mapping example 2 (twelfth time), the arrangement groups G1 to G5 specified in the first data mapping table 600 are mapped to the nodes NA to NC, NE, and NF according to a column node mapping CNM12.

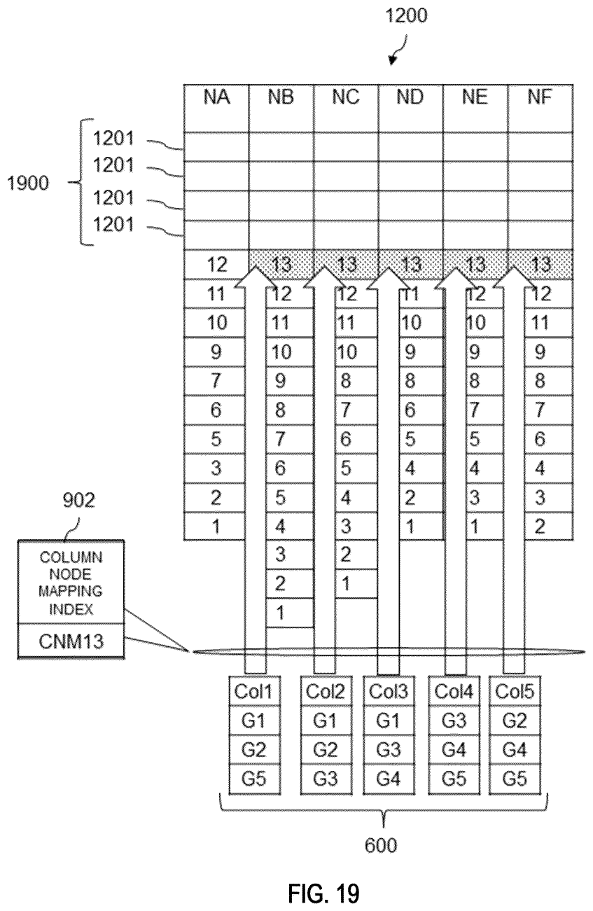

### [FIG. 19: Data Mapping Example 2 (Thirteenth Time)]

FIG. 19 is an explanatory diagram depicting the data mapping example 2 (thirteenth time). In the thirteenth data mapping, similarly to the data mapping example 2 (fourth time) depicted in FIG. 16, the arrangement groups G1 to G5 specified in the first data mapping table 600 are mapped to the nodes NB to NF according to a column node mapping CNM13.

In this manner, the thirteenth data mapping makes the unallocated capacity of the nodes NA to NF uniform. That is, unallocated capacity 1900 including four cell rows 1201 remains. As the unallocated capacity 1900, four cells remains in each column Col.

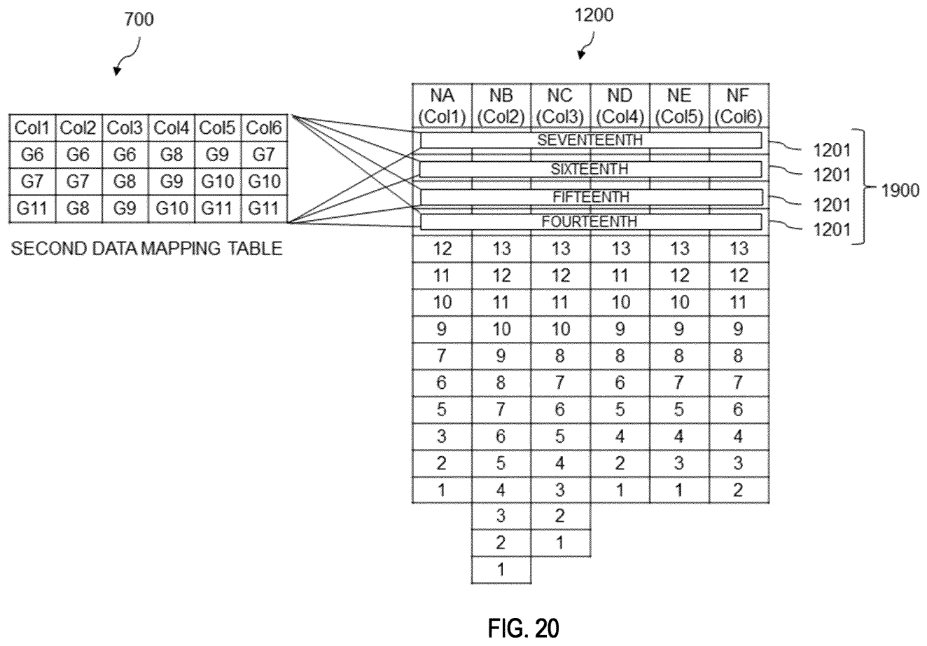

### [FIG. 20: Data Mapping Example 2 (Fourteenth to Seventeenth Times)]

FIG. 20 is an explanatory diagram depicting the data mapping example 2 (fourteenth to seventeenth times). After the thirteenth data mapping, as in the data mapping example 1 depicted in FIG. 12, the arrangement groups GX are allocated to the unallocated capacity 1900 of the node group configuration 1200 with use of the second data mapping table 700.

That is, in each of the fourteenth to seventeenth times, the arrangement groups G6 to G11 specified in the second data mapping table 700 are mapped to the nodes NA to NF according to column node mappings CNM14 to CNM17.

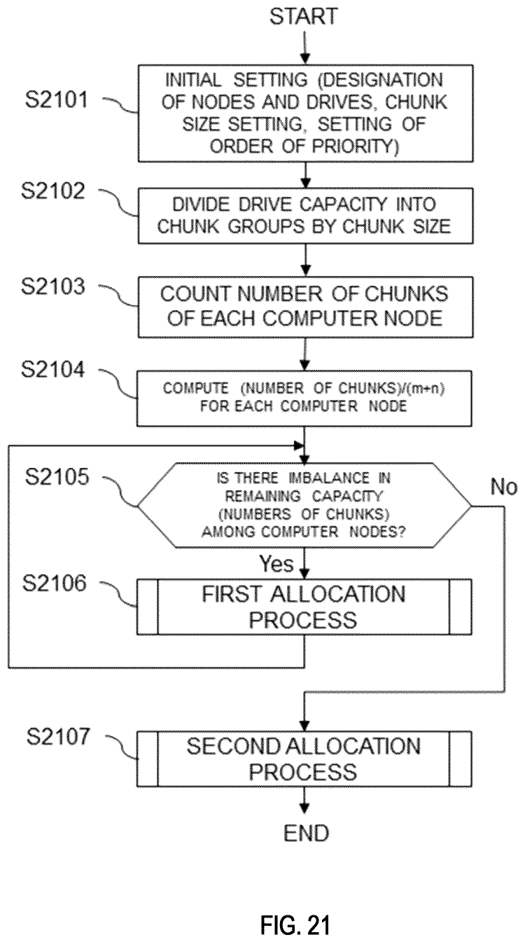

### <FIG. 21: Capacity Generation Process>

FIG. 21 is a flowchart depicting a capacity generation processing procedure example. For example, the capacity generation process depicted in FIG. 21 is executed by any of the computer nodes 110 depicted in FIG. 1. Note that the computer node 110 that executes the capacity generation process depicted in FIG. 21 may limit allocation destinations to only computer nodes 110 in the computer domain 101 to which the computer node 110 that executes the capacity generation process belongs, or may use, as allocation destinations, computer nodes 110 outside the computer domain 101 to which the computer node 110 that executes the capacity generation process belongs. Whereas any of the computer nodes 110 in FIG. 1 is explained as a process-executing entity in FIG. 21, the computer node 110 which is the process-executing entity may be included in allocation destinations, or may be excluded from the allocation destinations.

Note that an undepicted computer (having the control information table 200 and the management program 210) other than computer nodes 110 may execute the capacity generation process depicted in FIG. 21 and control allocation-destination computer nodes 110, if the computer is communicatively connected to the computer nodes 110 via the networks 102 and 120.

### (Step S2101)

The computer node 110 executes initial setting according to user operation, and proceeds to Step S2102. The initial setting includes designation of computer nodes 110 and drives 113 which are to be treated as allocation destinations of capacity, setting of a chunk size 802, and setting of priority criteria of allocation-destination nodes NX.

By the execution of designation of computer nodes 110 and drives 113, the designated drives 113 become available as allocation destinations. It is assumed in the present example that the nodes NA to NF are designated as allocation-destination computer nodes 110 and that at least some drives 113 of the nodes NA to NF are designated as allocation-destination drives 113. By the execution of setting of a chunk size 802, Step S2102 is executed with the set chunk sizes 802.

By the execution of setting of priority criteria of allocation-destination nodes NX, allocation-destination nodes NX are selected in accordance with the set priority criteria. In a case where a combination of selected allocation-destination nodes NX is new, an entry of the combination is generated in the column node correspondence management table 207. Note that, for example, priority criteria that can be adopted include “a priority criterion 1: nodes NX having the largest numbers of unallocated remaining chunks (blank cells in FIG. 13 are equivalent to five chunks) are selected,” “a priority criterion 2: nodes NX with the smallest numbers of times of prior selection are selected,” and “a priority criterion 3: nodes NX with the smallest node indices 301 are selected.”

More specifically, for example, there are five combinations of the priority criteria including a combination of the priority criterion 1 and the priority criterion 3 (if the priority criterion 1 is not enough to determine priority, the priority criterion 3 is used); a combination of the priority criterion 2 and the priority criterion 3 (if the priority criterion 2 is not enough to determine priority, the priority criterion 3 is used); a combination of the priority criterion 1, the priority criterion 2, and the priority criterion 3 (if the priority criterion 1 is not enough to determine priority, the priority criterion 2 is used, and if priority cannot be determined still, the priority criterion 3 is used); a combination of the priority criterion 2, the priority criterion 1, and the priority criterion 3 (if the priority criterion 2 is not enough to determine priority, the priority criterion 1 is used, and if priority cannot be determined still, the priority criterion 3 is used); and only the priority criterion 3. Note that the priority criterion 1 to the priority criterion 3 are examples, and priority criteria other than the priority criterion 1 to the priority criterion 3 can also be set.

### (Step S2102)

The computer node 110 divides the capacity 402 of each drive 113 designated at Step S2101, by the chunk size 802 set at Step S2101, and proceeds to Step S2103. By this division, chunks CK (DX) are generated in the drives 113. In addition, this generates each entry of the chunk management table 204.

### (Step S2103)

The computer node 110 counts the number of chunks of each allocation-destination computer node 110, and proceeds to Step S2104. Specifically, for example, the computer node 110 counts the number of chunks CK (DA) to CK (DF) that each of the nodes NA to NF has in its drives 113.

### (Step S2104)

For each allocation-destination computer node 110, the computer node 110 computes an evaluation value (=(the number of chunks)/(m+n)) for determining an imbalance, and proceeds to Step S2105. Since 2D1P is adopted in the present example, m+n=3.

### (Step S2105)

The computer node 110 determines whether or not there is an imbalance in unallocated remaining capacity among the allocation-destination computer nodes 110. Specifically, for example, in a case where all the evaluation values, each of which is calculated for an allocation-destination computer node 110 at Step S2104, match, the computer node 110 determines that there is no imbalance in unallocated remaining capacity among the allocation-destination computer nodes 110, and proceeds to Step S2107. On the other hand, in a case where not all the evaluation values, each of which is calculated for an allocation-destination computer node 110 at Step S2104, match (in a case where there is even one different evaluation value), the computer node 110 determines that there is an imbalance in unallocated remaining capacity among the allocation-destination computer nodes 110, and proceeds to Step S2106.

Note that, although, at Step S2105, the computer node 110 determines that there is no imbalance in unallocated remaining capacity among the allocation-destination computer nodes 110 in a case where all the evaluation values, each of which is calculated for an allocation-destination computer node 110 at Step S2104, match, the computer node 110 may determine that there is no imbalance in unallocated remaining capacity among the allocation-destination computer nodes 110 in a case where the difference between the maximum value and the minimum value of the evaluation values, each of which is calculated for an allocation-destination computer node 110, is within a tolerance range.

### (Step S2106)

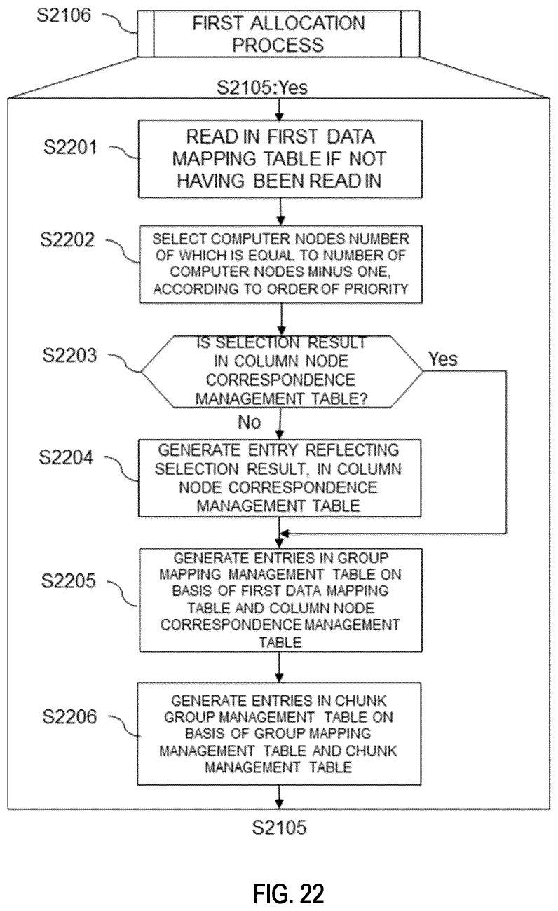

The computer node 110 executes a first allocation process, and returns to Step S2105. The first allocation process is the allocation process depicted in the data mapping example 2 in FIG. 13 to FIG. 19, and is described later with reference to FIG. 22.

### (Step S2107)

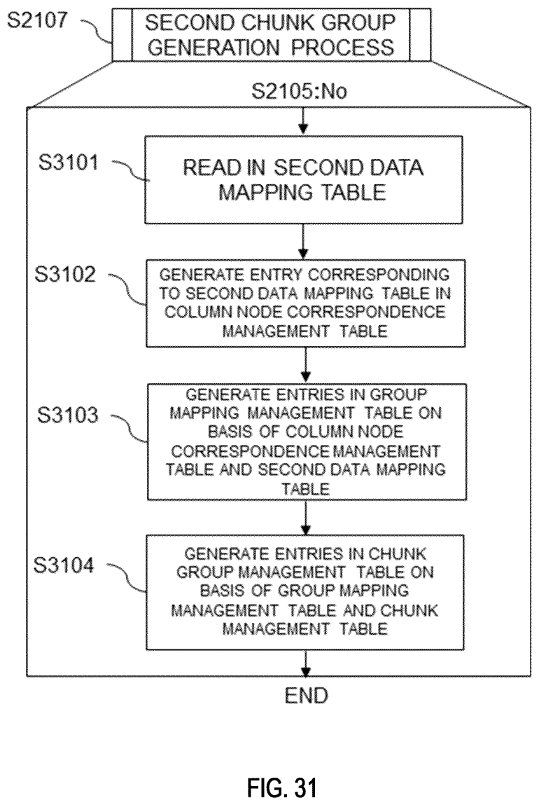

The computer node 110 executes a second allocation process, and ends the series of processing. The second allocation process is the allocation process depicted in the data mapping example 2 in FIG. 20, and is described later with reference to FIG. 31.

### <FIG. 22: First Allocation Process (Step S2106)>

FIG. 22 is a flowchart depicting a detailed processing procedure example of the first allocation process (Step S2106).

### (Step S2201)

If the first data mapping table 600 has not been read in, the computer node 110 reads in the first data mapping table 600, and proceeds to Step S2202.

### (Step S2202)

The computer node 110 selects allocation-destination computer nodes 110 the number of which is equal to the number of allocation-destination computer nodes minus one, in accordance with the priority criteria, and proceeds to Step S2203. Since the allocation-destination computer nodes are the nodes NA to NF in the present example, the number of the allocation-destination computer nodes is six. Accordingly, the computer node 110 selects five computer nodes 110 in accordance with the priority criteria.

### (Step S2203)

The computer node 110 determines whether or not the result of the selection at Step S2202 is in the column node correspondence management table 207. In a case where the result of the selection at Step S2202 is in the column node correspondence management table 207 (Step S2203: Yes), the computer node 110 proceeds to Step S2205. In a case where the result of the selection at Step S2202 is not in the column node correspondence management table 207 (Step S2203: No), the computer node 110 proceeds to Step S2204.

### (Step S2204)

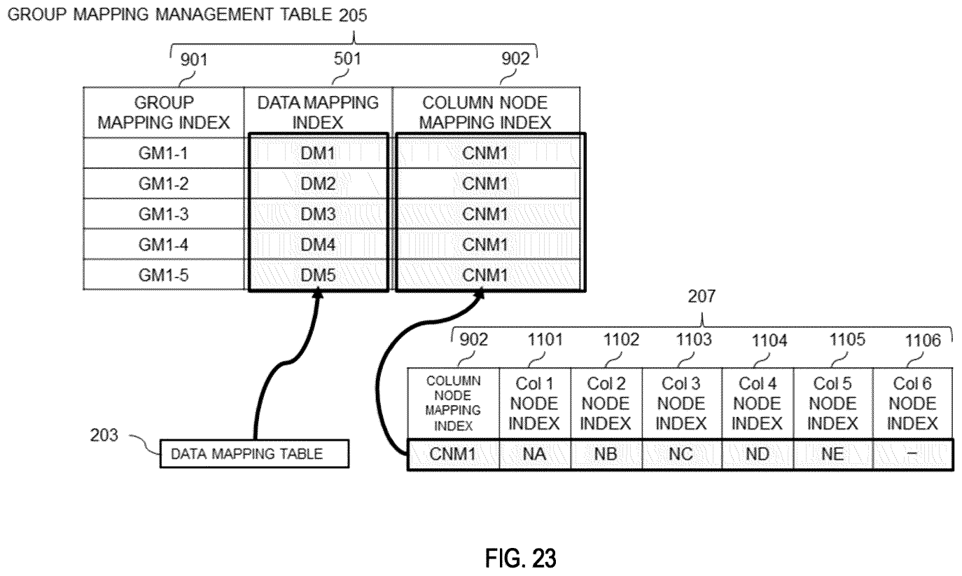

The computer node 110 generates an entry CNM # reflecting the selection result, in the column node correspondence management table 207, and proceeds to Step S2205. For example, in a case where the selection result is the nodes NA to NE in FIG. 13, the computer node 110 generates the entry CNM1 by numbering the entry “CNM1” as a column node mapping index 902 in the column node correspondence management table 207 and writing NA to NE as the Col1 node index 1101 to the Col5 node index 1105. A specific example of Step S2204 is described later with reference to FIG. 23.

### (Step S2205)

The computer node 110 generates entries GM # in the group mapping management table 205 on the basis of the first data mapping table 600 and the column node correspondence management table 207, and proceeds to Step S2206. Data mappings DM # selected from the first data mapping table 600 are written in the entries GM #. In addition, the column node mapping CNM # corresponding to the selection result in the column node correspondence management table 207 is written in the entries GM #.

Specifically, for example, in a case where the selection result is the nodes NA to NE in FIG. 13, the computer node 110 numbers group mapping indices 901 “GM1-1” to “GM1-5” in the group mapping management table 205. The computer node 110 selects the data mappings DM1 to DM5 from the first data mapping table 600, and writes “DM1” to “DM5” as data mapping indices 501 of entries GM1-1 to GM1-5.

The computer node 110 extracts, from the column node correspondence management table 207, the column node mapping CNM1 identified by the selection result indicating the nodes NA to NE, and writes “CNM1” as column node mapping indices 902 of the entries GM1-1 to GM1-5. As a result, the entries GM1 are generated. A specific example of Step S2205 is explained with reference to FIG. 23 to FIG. 29.

### (Step S2206)

The computer node 110 generates entries CG # in the chunk group management table 206 on the basis of the group mapping management table 205 and the chunk management table 204. Specifically, for example, in a case where the selection result is the nodes NA to NE in FIG. 13, the computer node 110 numbers a chunk group index 1000 “CG1-1” in the chunk group management table 206.

The computer node 110 writes, in the group mapping index 901 of the entry CG1-1 in the chunk group management table 206, “GM1-1,” which is the group mapping index 901 of the entry GM1-1 newly generated at Step S2205.

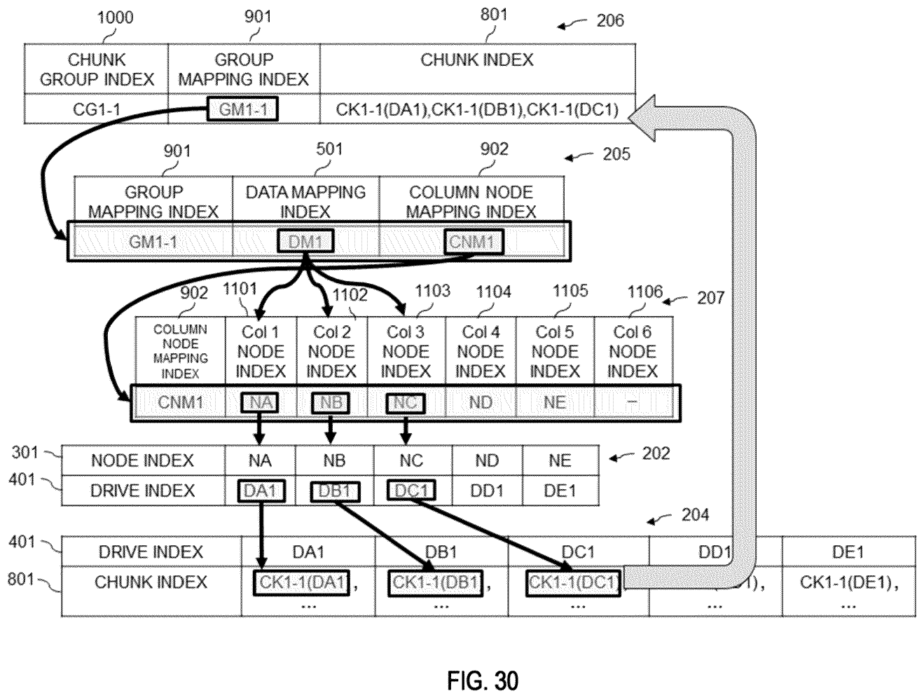

With reference to allocation flags 803 in the chunk management table 204, the computer node 110 selects chunks CK #(DX #) in drives DX having allocation flags 803 which are “0” representing not being allocated and having indices X of allocation-destination nodes NX, and writes the chunks CK #(DX #) as the chunk indices 801 of the entry CG1-1 in the chunk group management table 206. The selection-target chunks CK (DX) are chunks CK (DX) having allocation flags 803 which are “0,” and, after being selected at Step S2206, the allocation flags 803 of the chunks CK (DX) are updated to “1.” A specific example of Step S2206 is explained with reference to FIG. 30.

### <FIG. 23 to FIG. 29: Entry Generation Example 1 of Group Mapping Management Table 205>

Next, an entry generation example 1 of the group mapping management table 205 which is an example of the generation of entries described in Step S2205 is explained with reference to FIG. 23 to FIG. 29.

### [FIG. 23: Generation Example of Entries GM1-1 to GM1-5]

FIG. 23 is an explanatory diagram depicting a generation example of the entries GM1-1 to GM1-5. At Step S2205, in the first data mapping depicted in FIG. 13, group mapping indices 901 are numbered “GM1-1” to “GM1-5,” and are associated with “DM1” to “DM5” as data mapping indices 501.

In addition, since allocation to the node group configuration 1200 is executed according to the entry CNM1, which is the selection result, in the first data mapping depicted in FIG. 13, the group mapping indices 901 are associated with “CNM1” as column node mapping indices 902. In this manner, the entries GM1 are generated.

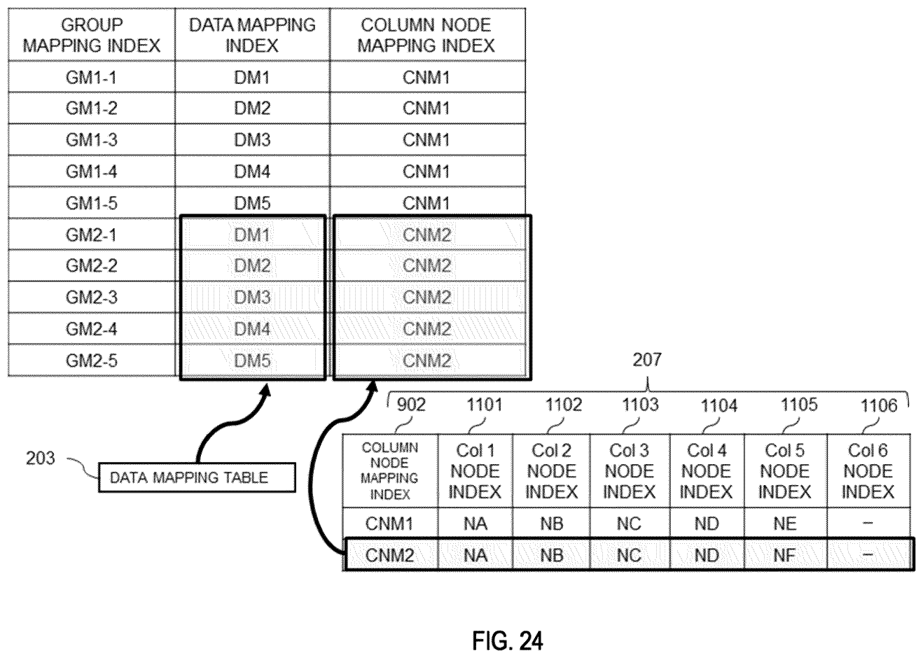

### [FIG. 24: Generation Example of Entries GM2-1 to GM2-5]

FIG. 24 is an explanatory diagram depicting a generation example of entries GM2-1 to GM2-5. In the second data mapping depicted in FIG. 14, group mapping indices 901 are numbered “GM2-1” to “GM2-5,” and are associated with “DM1” to “DM5” as data mapping indices 501.

In addition, since allocation to the node group configuration 1200 is executed according to the entry CNM2, which is the selection result, in the second data mapping depicted in FIG. 14, the group mapping indices 901 are associated with “CNM2” as column node mapping indices 902. In this manner, the entries GM2-1 to GM2-5 are generated.

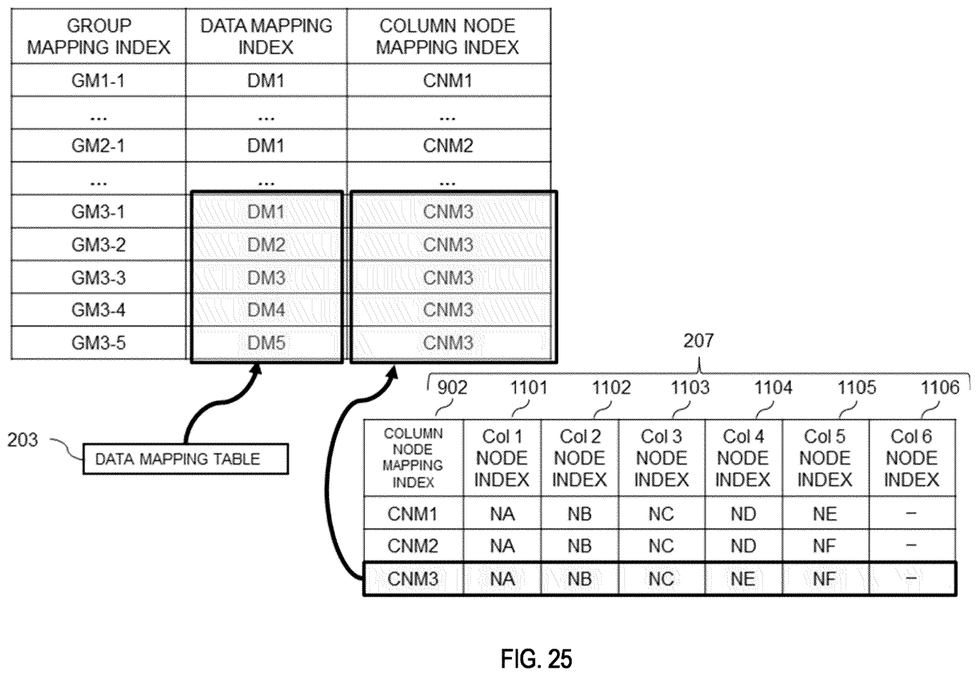

### [FIG. 25: Generation Example of Entries GM3-1 to GM3-5]

FIG. 25 is an explanatory diagram depicting a generation example of entries GM3-1 to GM3-5. In the third data mapping depicted in FIG. 15, group mapping indices 901 are numbered “GM3-1” to “GM3-5,” and are associated with “DM1” to “DM5” as data mapping indices 501.

In addition, since allocation to the node group configuration 1200 is executed according to the entry CNM3, which is the selection result, in the third data mapping depicted in FIG. 15, the group mapping indices 901 are associated with “CNM3” as column node mapping indices 902. In this manner, the entries GM3-1 to GM3-5 are generated.

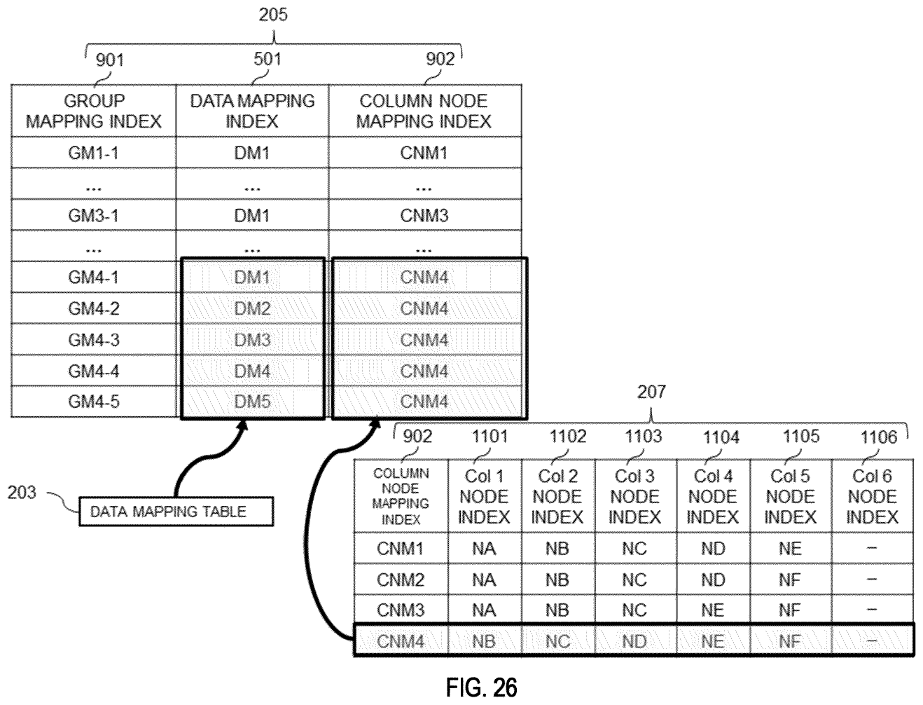

### [FIG. 26: Generation Example of Entries GM4-1 to GM4-5]

FIG. 26 is an explanatory diagram depicting a generation example of entries GM4-1 to GM4-5. In the fourth data mapping depicted in FIG. 16, group mapping indices 901 are numbered “GM4-1” to “GM4-5,” and are associated with “DM1” to “DM5” as data mapping indices 501.

In addition, since allocation to the node group configuration 1200 is executed according to the entry CNM4, which is the selection result, in the fourth data mapping depicted in FIG. 16, the group mapping indices 901 are associated with “CNM4” as column node mapping indices 902. In this manner, the entries GM4-1 to GM4-5 are generated.

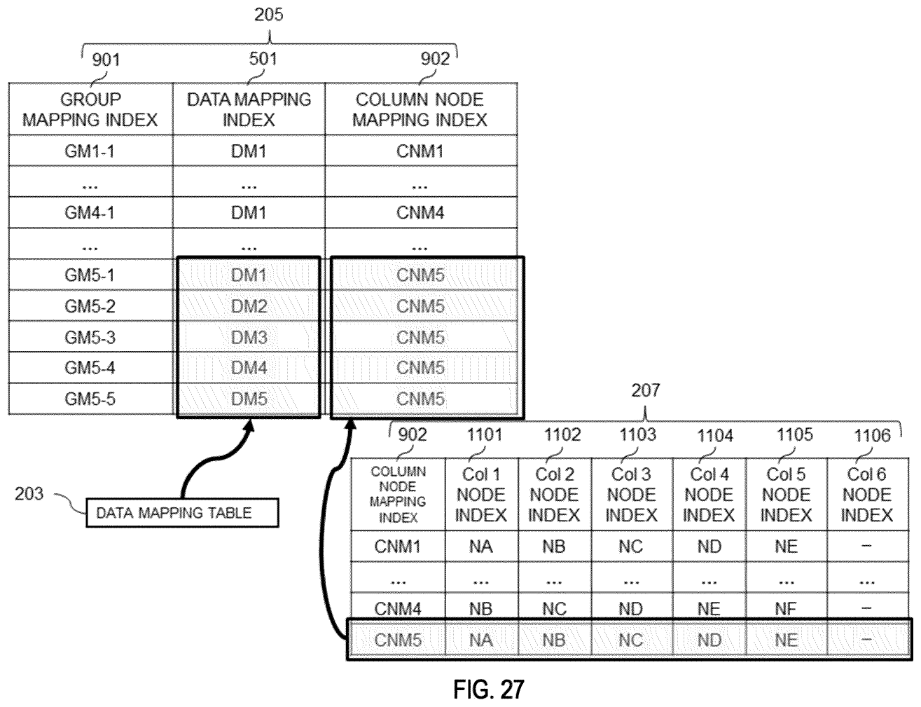

### [FIG. 27: Generation Example of Entries GM5-1 to GM5-5]

FIG. 27 is an explanatory diagram depicting a generation example of entries GM5-1 to GM5-5. In the fifth data mapping depicted in FIG. 17, group mapping indices 901 are numbered “GM5-1” to “GM5-5,” and are associated with “DM1” to “DM5” as data mapping indices 501.

In addition, since allocation to the node group configuration 1200 is executed according to the entry CNM5, which is the selection result, in the fifth data mapping depicted in FIG. 17, the group mapping indices 901 are associated with “CNM5” as column node mapping indices 902. In this manner, the entries GM5-1 to GM5-5 are generated.

### [Not Depicted: Generation Example of Entries GM6-1 to GM8-5]

In the sixth to eighth data mappings, group mapping indices 901 are numbered “GM6-1” to “GM6-5,” “GM7-1” to “GM7-5,” and “GM8-1” to “GM8-5,” and are associated with “DM1” to “DM3” as data mapping indices 501.

In addition, since allocation to the node group configuration 1200 is executed according to the entries CNM6 to CNM8, which are the selection results, in the sixth to eighth data mappings, the group mapping indices 901 are associated with “CNM6” to “CNM8” as column node mapping indices 902. In this manner, the entries GM6-1 to GM8-5 are generated.

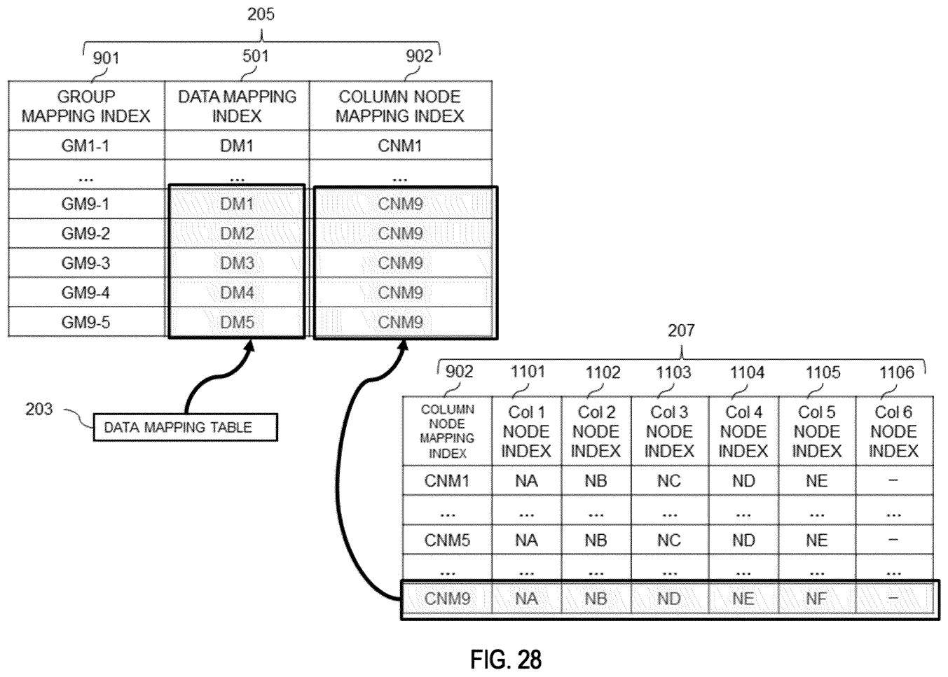

### [FIG. 28: Generation Example of Entries GM9-1 to GM9-5]

FIG. 28 is an explanatory diagram depicting a generation example of entries GM9-1 to GM9-5. In the ninth data mapping depicted in FIG. 18, group mapping indices 901 are numbered “GM9-1” to “GM9-5,” and are associated with “DM1” to “DM5” as data mapping indices 501.

In addition, since allocation to the node group configuration 1200 is executed according to the entry CNM9, which is the selection result, in the ninth data mapping depicted in FIG. 18, the group mapping indices 901 are associated with “CNM9” as column node mapping indices 902. In this manner, the entries GM9-1 to GM9-5 are generated.

### [Not Depicted: Generation Example of Entries GM10-1 to GM12-5]

In the tenth to twelfth data mappings, group mapping indices 901 are numbered “GM10-1” to “GM10-5,” “GM11-1” to “GM11-5,” and “GM12-1” to “GM12-5,” and are associated with “DM5,” “DM1,” and “DM2” as data mapping indices 501.

In addition, since allocation to the node group configuration 1200 is executed according to the entries CNM10 to CNM12, which are the selection results, in the tenth to twelfth data mappings, the group mapping indices 901 are associated with “CNM10” to “CNM12” as column node mapping indices 902. In this manner, the entries GM10-1 to GM12-5 are generated.

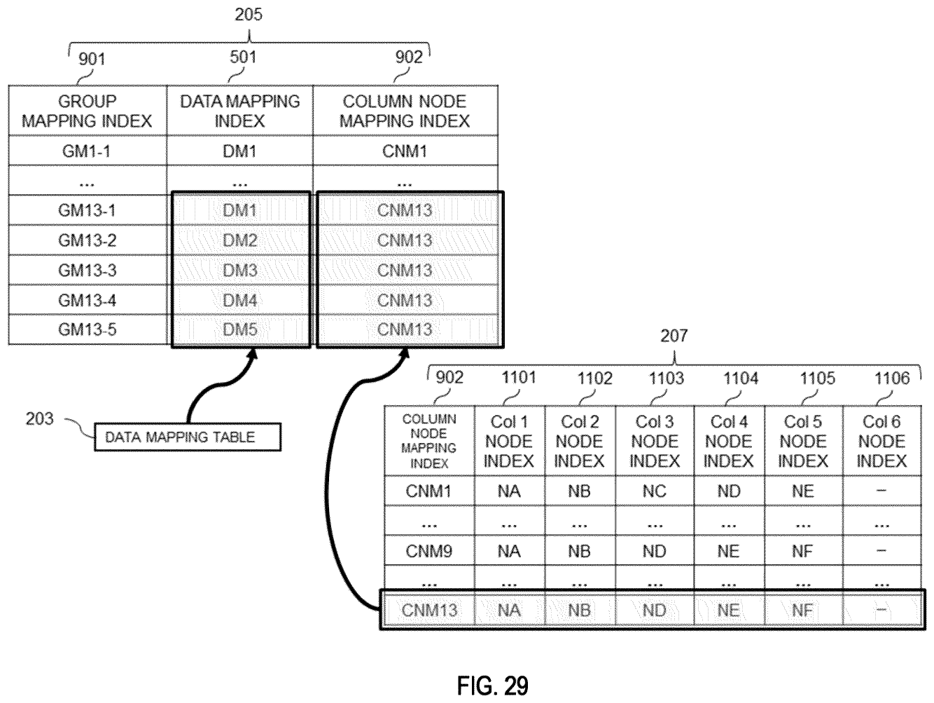

### [FIG. 29: Generation Example of Entries GM13-1 to GM13-5]

FIG. 29 is an explanatory diagram depicting a generation example of entries GM13-1 to GM13-5. In the thirteenth data mapping depicted in FIG. 19, group mapping indices 901 are numbered “GM13-1” to “GM13-5,” and are associated with “DM1” to “DM5” as data mapping indices 501.

In addition, since allocation to the node group configuration 1200 is executed according to the entry CNM13, which is the selection result, in the thirteenth data mapping depicted in FIG. 19, the group mapping indices 901 are associated with “CNM13” as column node mapping indices 902. In this manner, the entries GM13-1 to GM13-5 are generated.

### <FIG. 30: Entry Generation Example 1 of Chunk Group Management Table 206>

FIG. 30 is an explanatory diagram depicting an entry generation example 1 of the chunk group management table 206. As an example, a process for associating chunks CK (DX) with the group mapping GM1-1 at Step S2206 is explained with reference to FIG. 30.

First, a chunk group index 1000 is numbered “CG1-1,” and is associated with the group mapping GM1-1. In addition, in the group mapping management table 205, the group mapping GM1-1 is associated with the data mapping DM1 and the column node mapping CNM1.

Accordingly, “NA,” “NB,” and “NC,” which are the values of the Col1 node index 1101, the Col2 node index 1102, and the Col3 node index 1103 of {Col1, Col2, Col3}, which are the arrangement positions 505 of the data mapping DM1 in the column node mapping CNM1, are identified as node indices 301.

In the drive management table 202, “NA,” “NB,” and “NC,” which are the node indices 301, are associated with the values of drive indices 401, “DA1,” “DB1,” and “DC1.” Note that, although they are associated also with DA2, . . . , DB2, . . . , DC2, . . . , any of DA2, . . . , DB2, . . . , DC2, . . . may be used as long as unallocated chunks CK (DA), CK (DB), and CK (DC) are included.

In the chunk management table 204, the drives DA1, DB1, and DC1 have the chunks CK1-1 (DA1), CK1-1 (DB1), and CK1-1 (DC1) as unallocated chunks CK (DA), CK (DB), and CK (DC), respectively. Accordingly, as chunk indices 801, the chunks CK1-1 (DA1), CK1-1 (DB1), and CK1-1 (DC1) are associated with the chunk group CG1-1. As a result, the entry CG1-1 is generated. Similar processes are executed also for the group mappings GM1-2 to GM1-5, . . . , and GM13-5.

### <FIG. 31: Second Chunk Group Generation Process (Step S2107)>

FIG. 31 is a flowchart depicting a detailed processing procedure example of a second chunk group generation process (Step S2107).

### (Step S3101)

The computer node 110 reads in the second data mapping table 700, and proceeds to Step S3102.

### (Step S3102)

The computer node 110 generates an entry corresponding to the second data mapping table 700 in the column node correspondence management table 207, and proceeds to Step S3103. Specifically, for example, the computer node 110 generates the entry CNM6 in the column node correspondence management table 207.

Since the map size 503 of the second data mapping table 700 is “6,” the generated entry CNM designates the Col1 node index 1101 to the Col6 node index 1106, that is, the six nodes NA to NF. Accordingly, selection according to priority criteria like the selection at Step 2202 is not executed.

### (Step S3103)

The computer node 110 generates entries GM in the group mapping management table 205 on the basis of the column node correspondence management table 207 and the second data mapping table 700, and proceeds to Step S3104.

Specifically, for example, the computer node 110 numbers group mapping indices 901 the number of which is equal to the map size 503 of the second data mapping table 700, and associates each of the group mapping indices 901 with one of the data mapping indices 501 of the second data mapping table 700. In addition, the computer node 110 generates the entries GM in the group mapping management table 205 by associating each of the group mapping indices 901 with the column node mapping index 902 generated at Step S3102.

### (Step S3104)

The computer node 110 generates entries CG in the chunk group management table 206 on the basis of the group mapping management table 205 and the chunk management table 204. Specifically, for example, the computer node 110 numbers chunk group indices 1000, and associates the chunk group indices 1000 with the group mapping indices 901 numbered in the group mapping management table 205 at Step S3103.

The computer node 110 identifies the data mapping indices 501 and the column node mapping indices 902 from the entries GM of the associated group mapping indices 901. Then, the computer node 110 identifies columns Col that are included in the identified entry CNM of the column node mapping indices 902 and are included in the arrangement positions 505 of the entries DM of the data mapping indices 501.

The computer node 110 identifies nodes NX corresponding to the identified columns Col, and identifies unallocated chunks CK (DX) in drives DX in the identified nodes NX. The computer node 110 generates an entry CG in the chunk group management table 206 by associating the chunk indices 801 of the identified chunks CK (DX) with the chunk group index 1000.

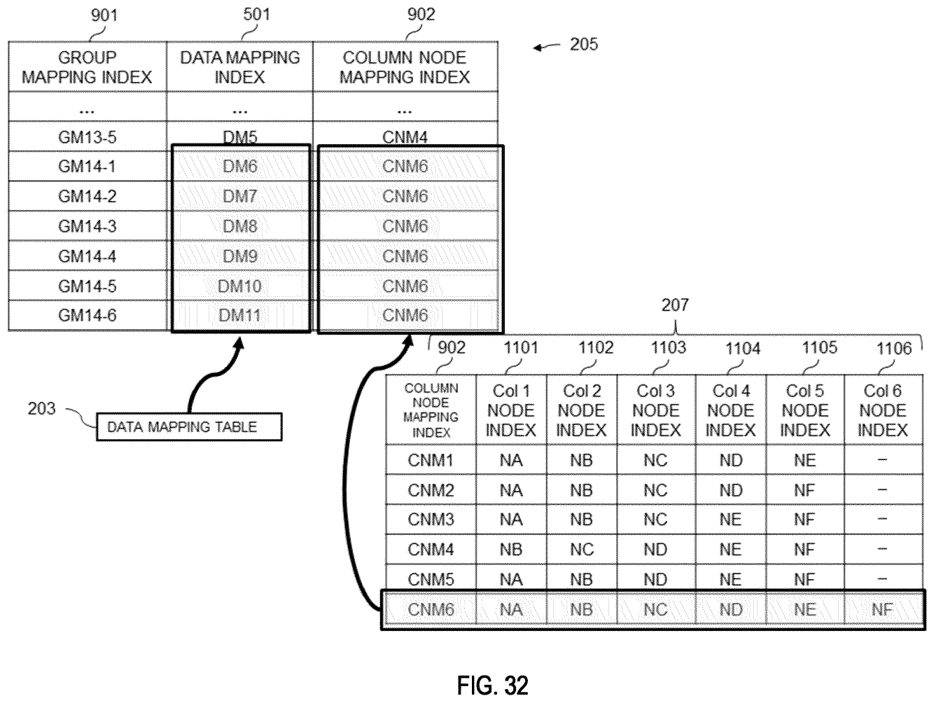

### <FIG. 32: Entry Generation Example 2 of Group Mapping Management Table 205>

FIG. 32 is an explanatory diagram depicting an entry generation example 2 of the chunk group management table 206 described in Step S3103. FIG. 32 depicts a generation example of entries GM14-1 to GM14-6. In the fourteenth data mapping depicted in FIG. 20, group mapping indices 901 are numbered “GM14-1” to “GM14-6,” and are associated with “DM6” to “DM11” as data mapping indices 501.

In addition, since allocation to the node group configuration 1200 is executed according to the entry CNM6 in the fourteenth data mapping depicted in FIG. 20, the group mapping indices 901 are associated with “CNM6” as column node mapping indices 902. In this manner, the entries GM14-1 to GM14-6 are generated.

Note that, also in the fifteenth to seventeenth data mappings depicted in FIG. 20, similarly, “DM6” to “DM11” as data mapping indices 501 and “CNM6” as a column node mapping index 902 are associated with the entries GM15-1 to GM15-6, GM16-1 to GM16-6, and GM17-1 to GM17-6.

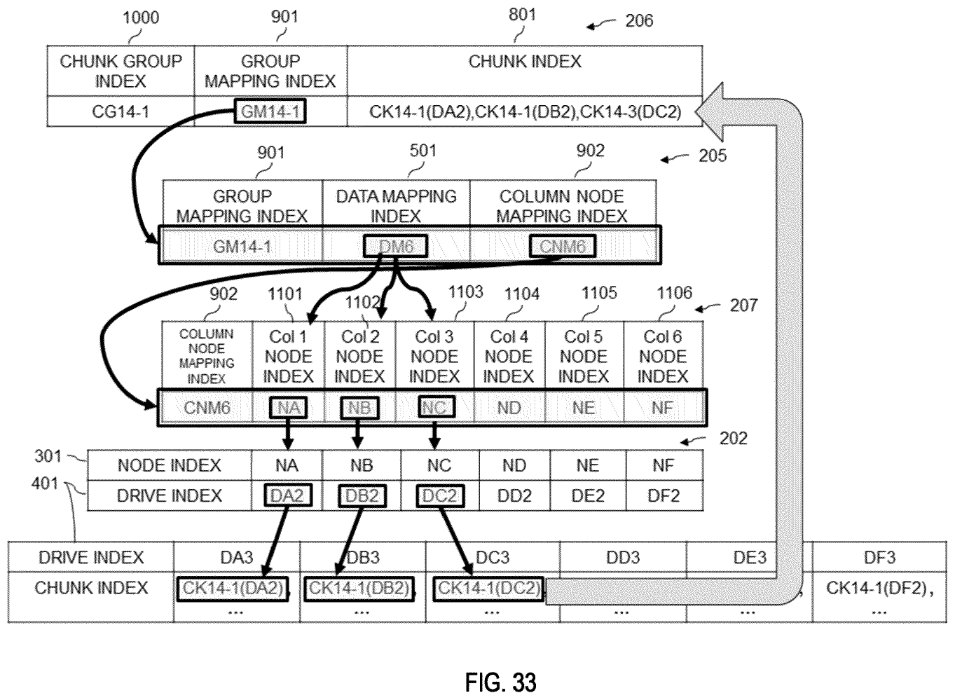

### <FIG. 33: Entry Generation Example 2 of Chunk Group Management Table 206>

FIG. 33 is an explanatory diagram depicting the entry generation example 2 of the chunk group management table 206. As an example, a process for associating chunks CK (DX) with the group mapping GM14-1 at Step S3104 is explained with reference to FIG. 33.

First, a chunk group index 1000 is numbered “CG14-1,” and is associated with the group mapping GM14-1. In addition, in the group mapping management table 205, the group mapping GM14-1 is associated with the data mapping DM6 and the column node mapping CNM6.

Accordingly, “NA,” “NB,” and “NC,” which are the values of the Col1 node index 1101, the Col2 node index 1102, and the Col3 node index 1103 of {Col1, Col2, Col3}, which are the arrangement positions 505 of the data mapping DM6 in the column node mapping CNM6, are identified as node indices 301.

In the drive management table 202, “NA,” “NB,” and “NC,” which are the node indices 301, are associated with the values of drive indices 401, “DA2,” “DB2,” and “DC2.” Note that, although they are associated also with DA1, . . . , DB1, . . . , DC1, DA3, . . . , DB3, . . . , DC3, . . . , any of DA1, . . . , DB1, . . . , DC1, DA3, . . . , DB3, . . . , DC3, . . . may be used as long as unallocated chunks CK (DA), CK (DB), and CK (DC) are included.

In the chunk management table 204, the drives DA2, DB2, and DC2 have the chunks CK14-1 (DA2), CK14-1 (DB2), and CK14-1 (DC2) as unallocated chunks CK (DA), CK (DB), and CK (DC), respectively. Accordingly, as chunk indices 801, the chunks CK14-1 (DA2), CK14-1 (DB2), and CK14-1 (DC2) are associated with the chunk group CG14-1. As a result, the entry CG14-1 is generated. Similar processes are executed also for the group mappings GM14-2 to GM14-6, . . . , GM17-6.

In this manner, according to the first embodiment, with use of the first data mapping table 600, it is possible to attempt to reduce unallocated remaining capacity due to an imbalance in capacity among computer nodes 110. In addition, after the reduction of the imbalance, it is possible to attempt to make capacity allocation efficient by applying the second data mapping table 700 corresponding to the number of the computer nodes 110.

### Second Embodiment

Next, a second embodiment is explained. Addition of capacity is explained in the second embodiment. Expansion of capacity by addition of drives 113 requires capacity defined in the second data mapping table 700 with a map size 503 equal to the number of computer nodes 110, and accordingly, drives 113 have to be added to all nodes NX.

In the second embodiment, expansion of capacity is realized by a configuration change (chunk rebalancing) of chunk groups CG allocated in the first data mapping table 600 to allocation in the second data mapping table 700.

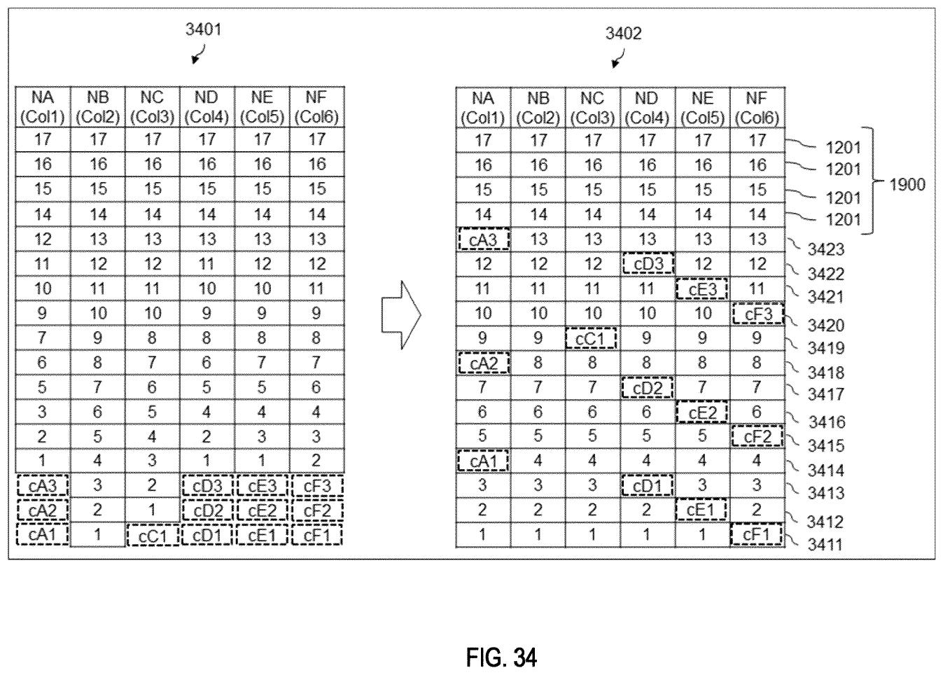

### <FIG. 34: Configuration Change (Chunk Rebalancing) Example>

FIG. 34 is an explanatory diagram depicting a configuration change (chunk rebalancing) example. A node group configuration 3401 represents a state where allocation of capacity has been completed according to the first embodiment. Each cell represents the capacity of (one chunk)×(three columns). The numerals in cells represent consecutive data-mapping numbers. That is, “1” to “13” represent the first to thirteenth data mappings to which the first data mapping table 600 has been applied, and “14” to “17” represent the fourteenth to seventeenth data mappings to which the second data mapping table 700 has been applied. In addition, cells represented by dotted rectangles represent cells for which drives 113 have not been set.

By performing sorting on the node group configuration 3401 such that the same data-mapping numbers are positioned in the same rows, a node group configuration 3402 is obtained. In the second embodiment, by allocating the capacity of the node NF to a cell cF1, the computer node 110 makes a configuration change to a data mapping in which the second data mapping table 700 has been applied to cell rows 3411 with the number “1.”

Similarly, by allocating the capacity of the node NE to a cell cE1, the computer node 110 makes a configuration change to a data mapping in which the second data mapping table 700 has been applied to a cell row 3412 with the number “2.”

In addition, by allocating the capacity of the node ND to a cell cD1, the computer node 110 makes a configuration change to a data mapping in which the second data mapping table 700 has been applied to a cell row 3413 with the number “3.”

In addition, by allocating the capacity of the node NA to a cell cA1, the computer node 110 makes a configuration change to a data mapping in which the second data mapping table 700 has been applied to a cell row 3414 with the number “4.”

In addition, by allocating the capacity of the node NF to a cell cF2, the computer node 110 makes a configuration change to a data mapping in which the second data mapping table 700 has been applied to a cell row 3415 with the number “5.”

In addition, by allocating the capacity of the node NE to a cell cE2, the computer node 110 makes a configuration change to a data mapping in which the second data mapping table 700 has been applied to a cell row 3416 with the number “6.”

In addition, by allocating the capacity of the node ND to a cell cD2, the computer node 110 makes a configuration change to a data mapping in which the second data mapping table 700 has been applied to a cell row 3417 with the number “7.”

In addition, by allocating the capacity of the node NA to a cell cA2, the computer node 110 makes a configuration change to a data mapping in which the second data mapping table 700 has been applied to a cell row 3418 with the number “8.”

In addition, by allocating the capacity of the node NC to a cell cC1, the computer node 110 makes a configuration change to a data mapping in which the second data mapping table 700 has been applied to a cell row 3419 with the number “9.”

In addition, by allocating the capacity of the node NF to a cell cF3, the computer node 110 makes a configuration change to a data mapping in which the second data mapping table 700 has been applied to a cell row 3420 with the number “10.”

In addition, by allocating the capacity of the node NE to a cell cE3, the computer node 110 makes a configuration change to a data mapping in which the second data mapping table 700 has been applied to a cell row 3421 with the number “11.”

In addition, by allocating the capacity of the node ND to a cell cD3, the computer node 110 makes a configuration change to a data mapping in which the second data mapping table 700 has been applied to a cell row 3422 with the number “12.”

In addition, by allocating the capacity of the node NA to a cell cA3, the computer node 110 makes a configuration change to a data mapping in which the second data mapping table 700 has been applied to a cell row 3423 with the number “13.”

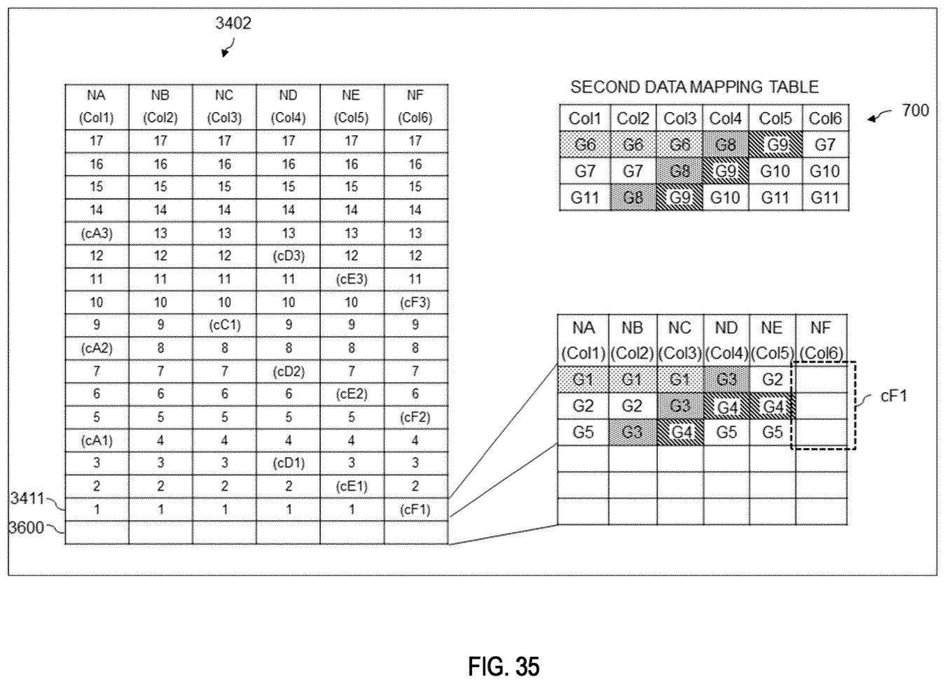

### <FIG. 35 to FIG. 38: Configuration Change 1>

Next, a configuration change 1 is explained with reference to FIG. 35 to FIG. 38.

### [FIG. 35: Arrangement Group Identification Example]

FIG. 35 is an explanatory diagram depicting an arrangement group identification example in the configuration change 1. In the example explained with reference to FIG. 35, a cell row which is a target of a configuration change is the cell rows 3411. Note that cell rows 3600 are a buffer area prepared for the configuration change. Data has been mapped to each cell of the nodes NA to NE in the cell rows 3411 with the number “1” according to the arrangement groups G1 to G5 in the first mapping table 600. Note that a drive 113 has not yet been set for the cell cF1.

If the data mapping of the cell rows 3411 to which the first data mapping table 600 has been applied and the second data mapping table 700 are compared with each other, both the arrangement groups G1 and G6 belong to the columns Col1 to Col3, both the arrangement groups G3 and G8 belong to the columns Col2 to Col4, and both the arrangement groups G4 and G9 belong to the columns Col3 to Col5. In a case where the way of combination of arrangement groups is the same in this manner, it is not necessary to move data, and it is sufficient if the arrangement indices 504 are updated such that G1 becomes G6, G3 becomes G8, and G4 becomes G9.

Accordingly, the computer node 110 compares the data mapping of the cell rows 3411 to which the first data mapping table 600 has been applied and the second data mapping table 700 with each other. The computer node 110 identifies (G1, G6), (G3, G8), and (G4, G9) as combinations of arrangement indices 504 to be changed.

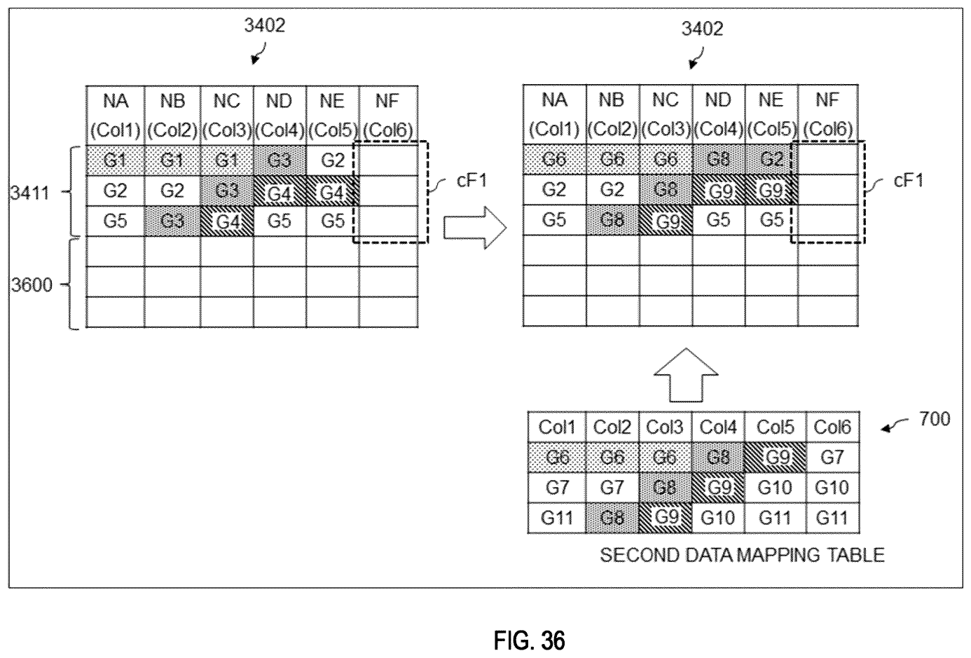

### [FIG. 36: Arrangement Group Change Example]

FIG. 36 is an explanatory diagram depicting an arrangement group change example in the configuration change 1. According to the combinations of arrangement indices 504 to be changed, the computer node 110 changes the arrangement groups G1, G3, and G4 representing data mappings of the cell rows 3411 to which the first data mapping table 600 has been applied to the arrangement groups G6, G8, and G9 in the second data mapping table 700.

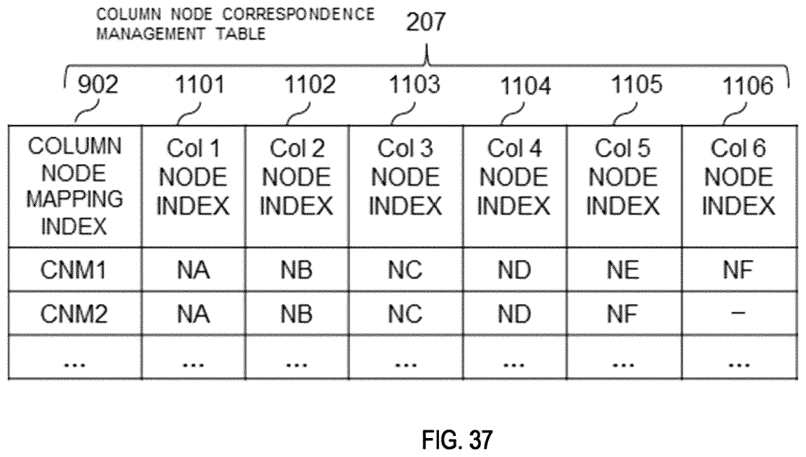

### [FIG. 37: Update Example of Column Node Correspondence Management Table 207]

FIG. 37 is an explanatory diagram depicting an update example 1 of the column node correspondence management table 207 in the configuration change 1. In the cell rows 3411, the arrangement groups G1 to G5 specified in the first data mapping table 600 are mapped to the nodes NA to NE according to the column node mapping index CNM1 (see FIG. 13).

The second data mapping table 700 is applied to the cell rows 3411 by the configuration change. The second data mapping table 700 has G7, G10, and G11 as arrangement indices 504 in the column Col6. Accordingly, the computer node 110 adds “NF” as the Col6 node index 1106 of the entry CNM1 in the column node correspondence management table 207.

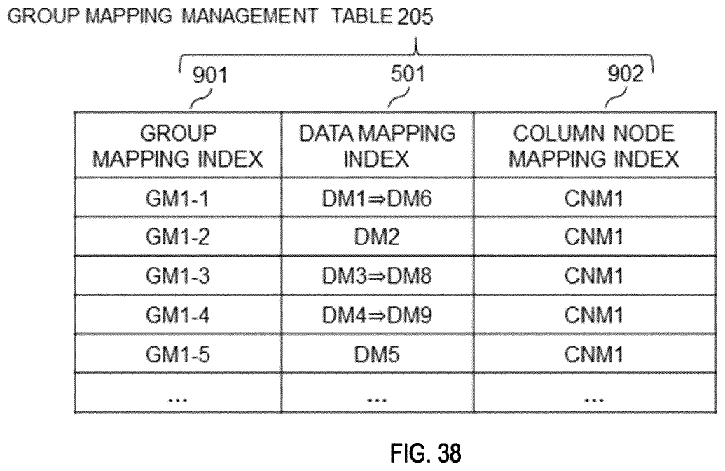

### [FIG. 38: Update Example of Group Mapping Management Table 205]

FIG. 38 is an explanatory diagram depicting an update example of the group mapping management table 205 in the configuration change 1. In order to change the arrangement groups G1, G3, and G4 representing the data mapping of the cell rows 3411 to which the first data mapping table 600 has been applied to the arrangement groups G6, G8, and G9 of the second data mapping table 700, the computer node 110 updates, in the group mapping management table 205, the data mapping index 501 of the entry GM1-1 from DM1 to the DM6, updates the data mapping index 501 of the entry GM1-3 from DM3 to DM8, and updates the data mapping index 501 of the entry GM1-4 from DM4 to DM9.

In this manner, in the configuration change 1, a configuration change from the first data mapping table 600 to the second data mapping table 700 is realized without moving data.

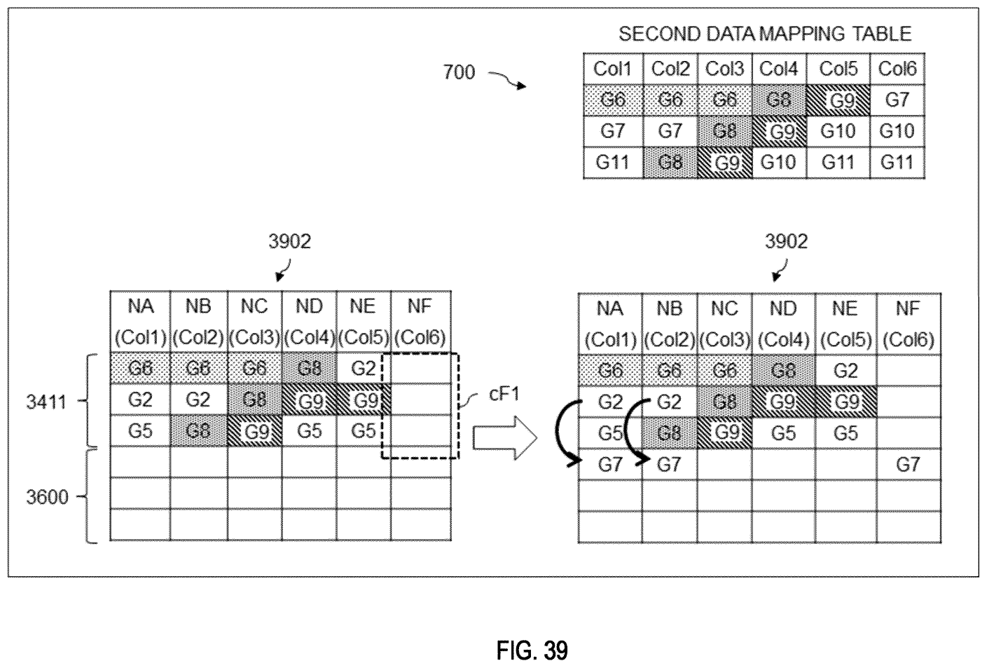

### <FIG. 39 to FIG. 42: Configuration Change 2>

Next, a configuration change 2 is explained with reference to FIG. 39 to FIG. 42. The configuration change 2 is executed after the configuration change 1.

### [FIG. 39: Arrangement Group Change Example]

FIG. 39 is an explanatory diagram depicting an arrangement group change example in the configuration change 2. It is assumed in FIG. 39 that the node group configuration 3402 that has been updated by the configuration change 1 is a node group configuration 3902.

If the data mapping of the cell rows 3411 to which the first data mapping table 600 has been applied and the second data mapping table 700 are compared with each other, both the arrangement groups G2 and G7 belong to the columns Col1 and Col2, but G7 belongs to the column Col6 in the second data mapping table 700. In a case where the ways of combination of arrangement groups are different in this manner, data needs to be moved to the cell rows 3600.

Accordingly, the computer node 110 compares the data mapping of the cell rows 3411 to which the first data mapping table 600 has been applied and the second data mapping table 700 with each other. Then, the computer node 110 identifies (G2, G7) as a combination of a movement source and a movement destination of arrangement indices 504.

According to the combination of a movement source and a movement destination of arrangement indices 504, the computer node 110 sets the arrangement group G7 in the second data mapping table 700 for cells, in the cell rows 3600, of the nodes NA and NB to which the arrangement group G2 belongs. In addition, the computer node 110 sets the arrangement group G7 belonging to the column Col6 of the second data mapping table 700 for a cell, in the cell rows 3600, of the column Col6 of the node NF to which the arrangement group G2 belongs.

As a result, data in the cell of the arrangement group G2 of the node NA in the cell rows 3411 is moved to the arrangement group G7 of the node NA in the cell rows 3600. Data in the cell of the arrangement group G2 of the node NB in the cell rows 3411 is moved to the arrangement group G7 of the node NB in the cell rows 3600. Since data that should be stored has not yet been stored in the node NF in the cell rows 3411, there is no data to be moved to the arrangement group G7 of the node NF in the cell rows 3600.

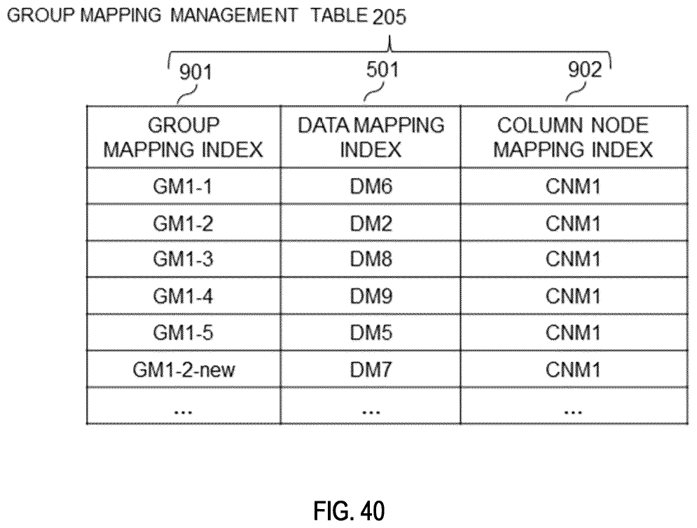

### [FIG. 40: Update Example of Group Mapping Management Table 205]

FIG. 40 is an explanatory diagram depicting an update example of the group mapping management table 205 in the configuration change 2. In order to change the arrangement group G2 representing the data mapping of the cell rows 3411 to which the first data mapping table 600 has been applied to the arrangement group G7 of the second data mapping table 700, the computer node 110 creates, in the group mapping management table 205, a new entry to be the data movement destination of an entry GM1-2. The computer node 110 sets “GM1-2-new” as a group mapping index 901 of the new entry, sets “DM7” to be the movement destination from the arrangement group G2 as a data mapping index 501, and sets “CNM1,” as with the entry GM1-2, as a column node mapping index 902.

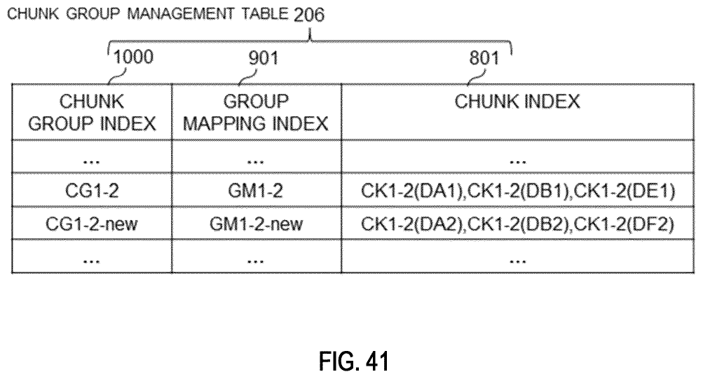

### [FIG. 41: Update Example of Chunk Group Management Table 206]

FIG. 41 is an explanatory diagram depicting an update example of the chunk group management table 206 in the configuration change 2. The computer node 110 creates a new entry in the chunk group management table 206, sets “CG1-2-new” as a chunk group index 1000, and sets “GM1-2-new” as a group mapping index 901.

Then, with reference to the chunk management table 204, the computer node 110 sets, as chunk indices 801, the chunk indices CK1-2 (DA2), CK1-2 (DB2), and CK1-2 (DC2) of chunks having allocation flags 803 which are “0,” in order to generate chunk groups in the nodes NA, NB, and NF of a data mapping DM7 (Col1, Col2, Col7). As a result, a new chunk group CG1-2-new is generated.

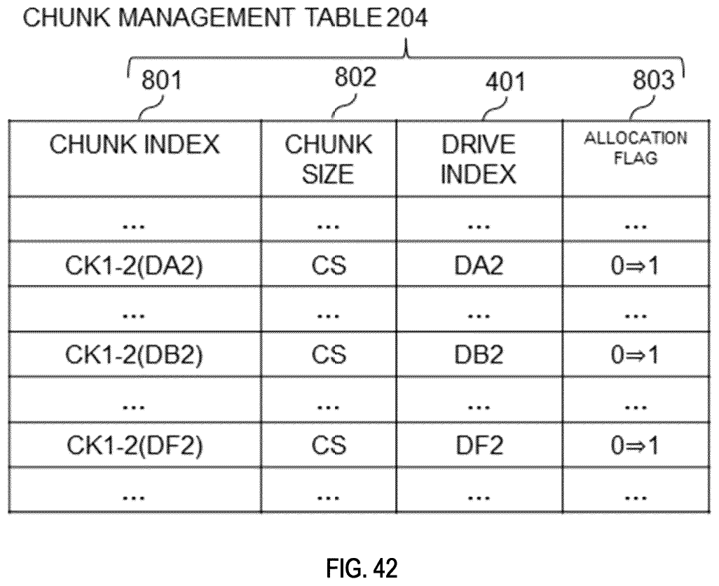

### [FIG. 42: Update Example of Chunk Management Table 204]

FIG. 42 is an explanatory diagram depicting an update example of the chunk management table 204 in the configuration change 2. The computer node 110 updates the allocation flags 803 of the chunk indices CK1-2 (DA2), CK1-2 (DB2), and CK1-2 (DF2) of the chunks having the allocation flags 803 which are “0,” from “0” to “1.”

In this manner, in the configuration change 2, a configuration change from the first data mapping table 600 to the second data mapping table 700 is realized by moving data to the cell rows 3600, which are a free area.

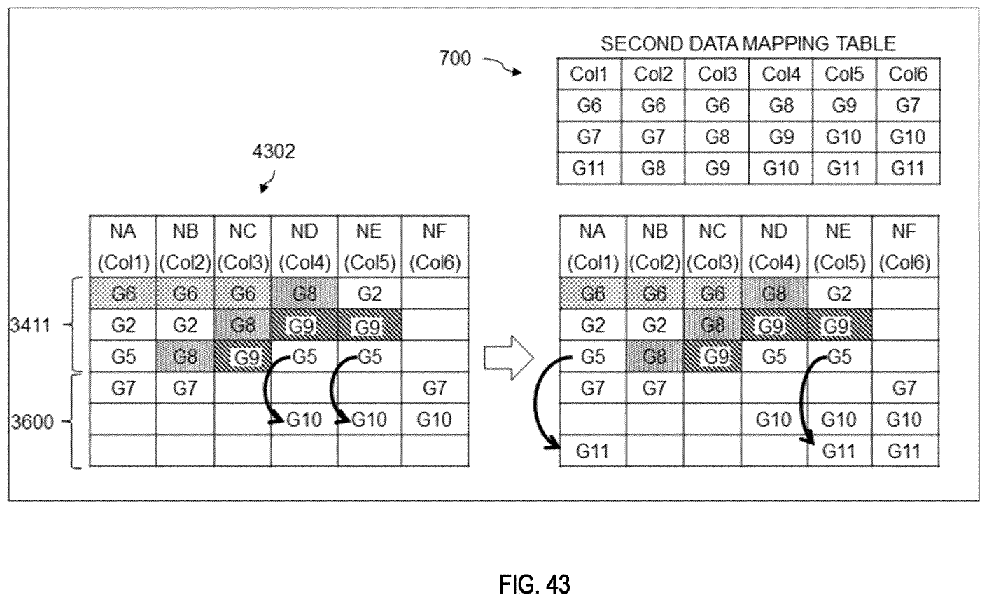

### <FIG. 43 to FIG. 46: Configuration Change 3>

Next, a configuration change 3 is explained with reference to FIG. 43 to FIG. 46. The configuration change 3 is executed after the configuration change 2.

### [FIG. 43: Arrangement Group Change Example]

FIG. 43 is an explanatory diagram depicting an arrangement group change example in the configuration change 3. It is assumed in FIG. 43 that the node group configuration 3902 that has been updated by the configuration change 2 is a node group configuration 4302.

If the data mapping of the cell rows 3411 to which the first data mapping table 600 has been applied and the second data mapping table 700 are compared with each other, both the arrangement groups G5 and G10 belong to the column Col4, and both the arrangement groups G5 and G11 belong to the columns Col1 and Col5. In addition, the arrangement groups G10 and G11 are arranged in the column Col6 of the second mapping table 700, but are not arranged in the node NF (Col6) in the data mapping of the cell rows 3411 to which the first data mapping table 600 has been applied. In a case where the ways of combination of arrangement groups are different in this manner, data needs to be moved to the cell rows 3600.

Accordingly, the computer node 110 compares the data mapping of the cell rows 3411 to which the first data mapping table 600 has been applied and the second data mapping table 700 with each other. Then, the computer node 110 identifies (G5, G10) and (G5, G11) as combinations of a movement source and a movement destination of arrangement indices 504, and identifies, as arrangement without movement sources, the arrangement groups G10 and G11 in the column Col6 in the second data mapping table 700.

According to the combination (G5, G10) of a movement source and a movement destination of arrangement indices 504, the computer node 110 sets the arrangement group G10 in the second data mapping table 700 for cells, in the cell rows 3600, of the nodes ND and NE to which the arrangement group G5 belongs. In addition, as arrangement without a movement source, the computer node 110 sets the arrangement group G10 in the column Col6 in the second data mapping table 700 for a cell of the node NF (Col6) in the cell rows 3600.

In addition, according to the combination (G5, G11) of a movement source and a movement destination of arrangement indices 504, the computer node 110 sets the arrangement group G11 in the second data mapping table 700 for cells, in the cell rows 3600, of the nodes NA and NE to which the arrangement group G5 belongs. In addition, as arrangement without a movement source, the computer node 110 sets the arrangement group G11 in the column Col6 in the second data mapping table 700 for a cell of the node NF (Col6) in the cell rows 3600.

As a result, data in the cell of the arrangement group G5 of the node ND in the cell rows 3411 is moved to the cell of the arrangement group G10 of the node ND in the cell rows 3600. Data in the cell of the arrangement group G5 of the node NE in the cell rows 3411 is moved to the cell of the arrangement group G10 of the node NE in the cell rows 3600. Since data that should be stored has not yet been stored in the node NF in the cell rows 3411, there is no data to be moved to the cell of the arrangement group G10 of the node NF in the cell rows 3600.

In addition, similarly, data in the cell of the arrangement group G5 of the node NA in the cell rows 3411 is moved to the cell of the arrangement group G11 of the node NA in the cell rows 3600. Data in the cell of the arrangement group G5 of the node NE in the cell rows 3411 is moved to the cell of the arrangement group G11 of the node NE in the cell rows 3600. Since data that should be stored has not yet been stored in the node NF in the cell rows 3411, there is no data to be moved to the cell of the arrangement group G11 of the node NF in the cell rows 3600.

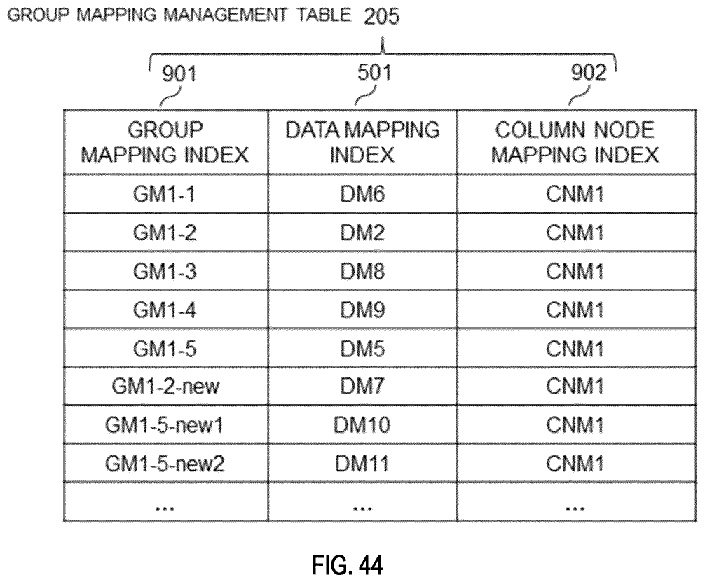

### [FIG. 44: Update Example of Group Mapping Management Table 205]

FIG. 44 is an explanatory diagram depicting an update example of the group mapping management table 205 in the configuration change 3. In order to change the arrangement group G5 representing the data mapping of the cell rows 3411 to which the first data mapping table 600 has been applied to the arrangement group G10 of the second data mapping table 700, the computer node 110 creates, in the group mapping management table 205, a new entry to be the data movement destination of an entry GM1-5. The computer node 110 sets “GM1-5-new1” as a group mapping index 901 of the new entry, sets “DM10” to be the movement destination from the arrangement group G5 as a data mapping index 501, and sets “CNM1,” as with the entry GM1-5, as a column node mapping index 902.

In addition, the computer node 110 creates a new entry to be the data movement destination of the entry GM1-5 in the group mapping management table 205. The computer node 110 sets “GM1-5-new2” as a group mapping index 901 of the new entry, sets “DM11” to be the movement destination from the arrangement group G5 as a data mapping index 501, and sets “CNM16,” as with the entry GM1-5, as a column node mapping index 902.

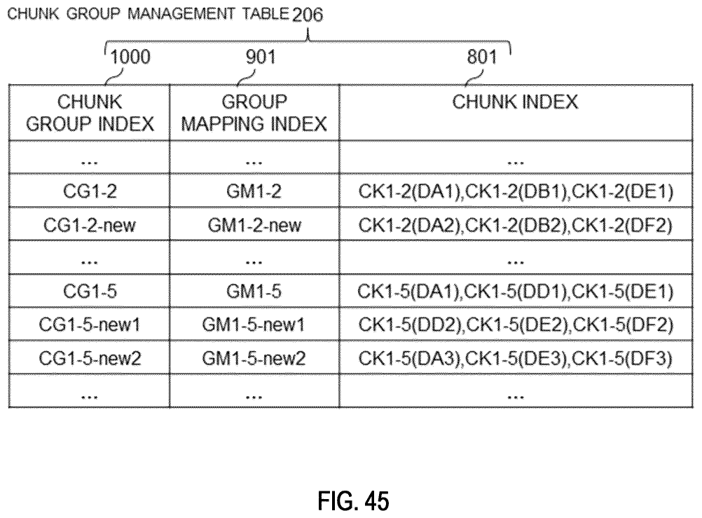

### [FIG. 45: Update Example of Chunk Group Management Table 206]

FIG. 45 is an explanatory diagram depicting an update example of the chunk group management table 206 in the configuration change 3. The computer node 110 creates a new entry in the chunk group management table 206, sets “CG1-5-new1” as a chunk group index 1000, and sets “GM1-5-new1” as a group mapping index 901.

Then, with reference to the chunk management table 204, the computer node 110 sets, as chunk indices 801, the chunk indices CK1-5 (DD2), CK1-5 (DE2), and CK1-5 (DF2) of chunks having allocation flags 803 which are “0,” in order to generate chunk groups in the nodes ND, NE, and NF of a data mapping DM10 (Col4, Col5, Col6). As a result, a new chunk group CG1-5-new1 is generated.

Similarly, the computer node 110 creates a new entry in the chunk group management table 206, sets “CG1-5-new2” as a chunk group index 1000, and sets “GM1-5-new2” as a group mapping index 901.

Then, with reference to the chunk management table 204, the computer node 110 sets, as chunk indices 801, the chunk indices CK1-5 (DA3), CK1-5 (DE3), and CK1-5 (DF3) of chunks having allocation flags 803 which are “0,” in order to generate chunk groups in the nodes NA, NE, and NF of a data mapping DM11 (Col1, Col5, Col6). As a result, a new chunk group CG1-5-new2 is generated.

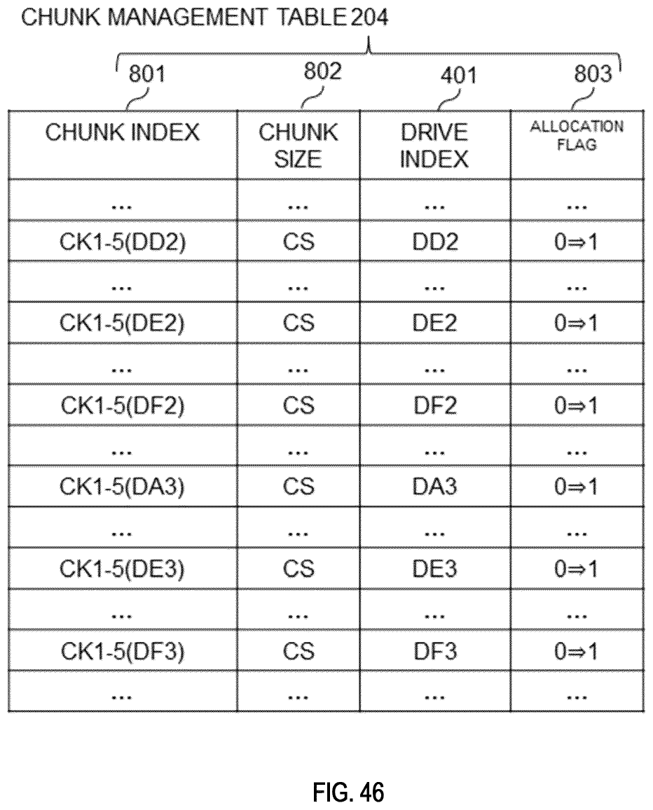

### [FIG. 46: Update Example of Chunk Management Table 204]

FIG. 46 is an explanatory diagram depicting an update example of the chunk management table 204 in the configuration change 3. The computer node 110 updates the allocation flags 803 of the chunk indices CK1-5 (DD2), CK1-5 (DE2), CK1-5 (DF2), CK1-5 (DA3), CK1-5 (DE3), and CK1-5 (DF3) of the chunks having the allocation flags 803 which are “₀,” from “0” to “1.”

In this manner, in the configuration change 3, similarly to the configuration change 2, a configuration change from the first data mapping table 600 to the second data mapping table 700 is realized by moving data to the cell rows 3600, which are a free area.

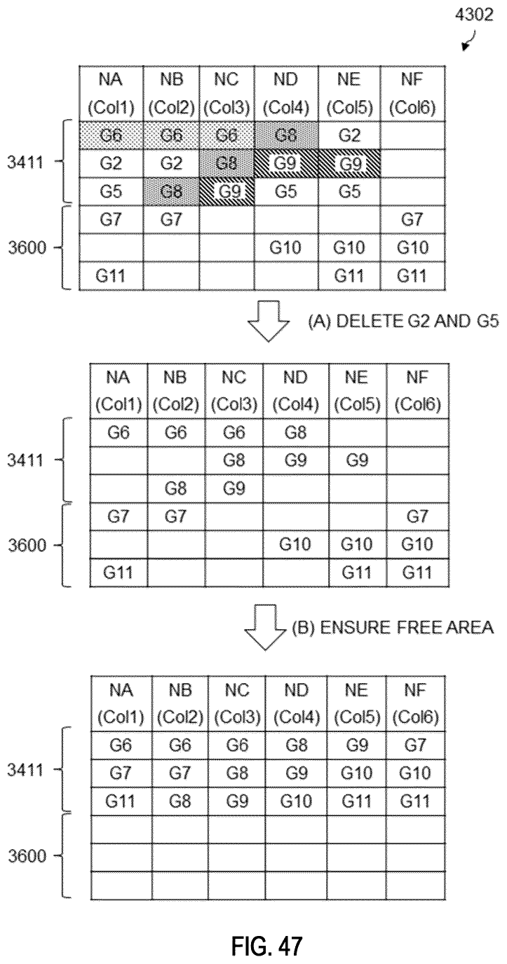

### <FIG. 47 to FIG. 50: Unnecessary Arrangement Group Deletion>

Next, unnecessary arrangement group deletion examples at the end of a configuration change are explained with reference to FIG. 47 to FIG. 50.

### [FIG. 47: Unnecessary Arrangement Group Deletion in Node Group Configuration 4302]

FIG. 47 is an explanatory diagram depicting an unnecessary arrangement group deletion example regarding the node group configuration 4302.

(A) Since data in the cells of the arrangement group G2 has been moved to the cells of the arrangement group G7, the data in the cells of the arrangement group G2 is not necessary. Accordingly, the data in the cells of the arrangement group G2 is deleted from the nodes NA, NB, and NE. Since data in the cells of the arrangement group G5 has been moved to the cells of the arrangement groups G10 and G11, the data in the cells of the arrangement group G5 is not necessary. Accordingly, the data in the cells of the arrangement group G5 is deleted from the nodes NA, ND, and NE.

(B) The computer node 110 moves data in the cells of the groups G7, G10, and G11 arranged in the cell rows 3600 to the cell rows 3411 in the same nodes NX. As a result, the cell rows 3600 are released from the arrangement groups, and become available as a new chunk rebalancing area.

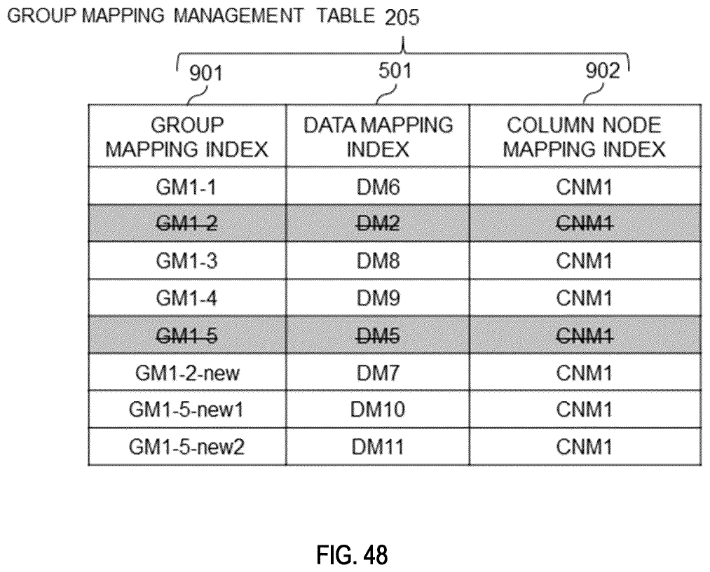

### [FIG. 48: Unnecessary Arrangement Group Deletion in Group Mapping Management Table 205]

FIG. 48 is an explanatory diagram depicting an unnecessary arrangement group deletion example regarding the group mapping management table 205. Since the arrangement groups G2 and G5 are unnecessary arrangement groups, the computer node 110 deletes the entry GM1-2 corresponding to the arrangement group G2 and the entry GM1-5 corresponding to the arrangement group G5 in the group mapping management table 205.

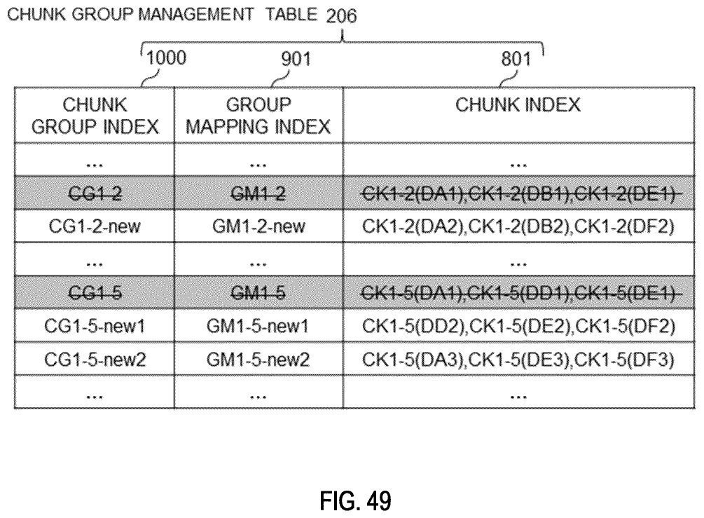

### [FIG. 49: Unnecessary Arrangement Group Deletion in Chunk Group Management Table 206]

FIG. 49 is an explanatory diagram depicting an unnecessary arrangement group deletion example regarding the chunk group management table 206. Since the arrangement groups G2 and G5 are unnecessary arrangement groups, the computer node 110 deletes the entry CG1-2 corresponding to the arrangement group G2 and the entry CG1-5 corresponding to the arrangement group G5 in the chunk group management table 206.

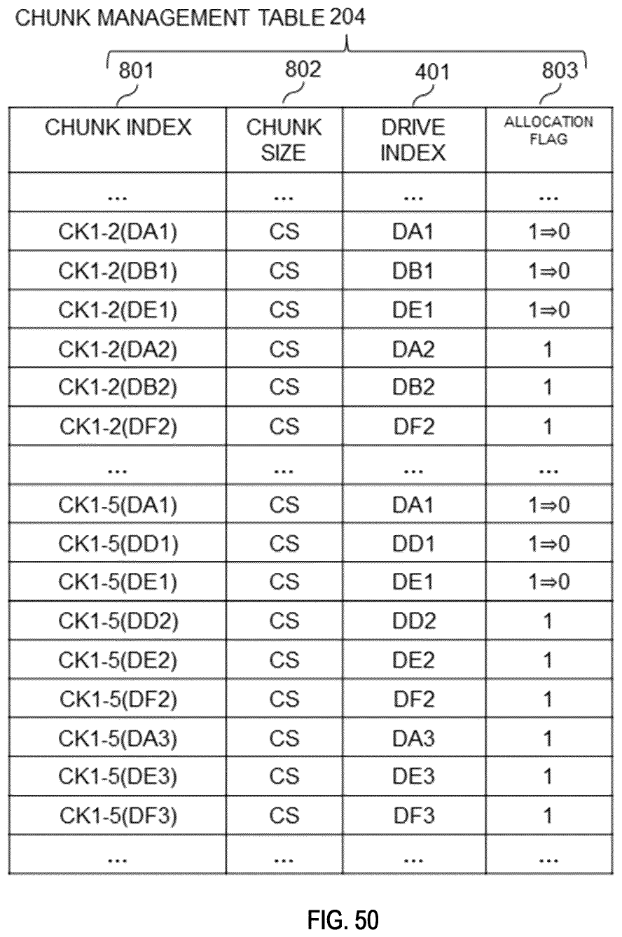

### [FIG. 50: Unnecessary Arrangement Group Deletion in Chunk Management Table 204]

FIG. 50 is an explanatory diagram depicting an unnecessary arrangement group deletion example regarding the chunk management table 204. Since the arrangement groups G2 and G5 are unnecessary arrangement groups, in the chunk management table 204, the computer node 110 updates the allocation flags 803 of chunks identified by the chunk indices 801 of the chunk group CG1-2 corresponding to the arrangement group G2 from “1” to “0,” and updates the allocation flags 803 of chunks identified by the chunk indices 801 of the chunk group CG1-5 corresponding to the arrangement group G5 from “1” to “0.”

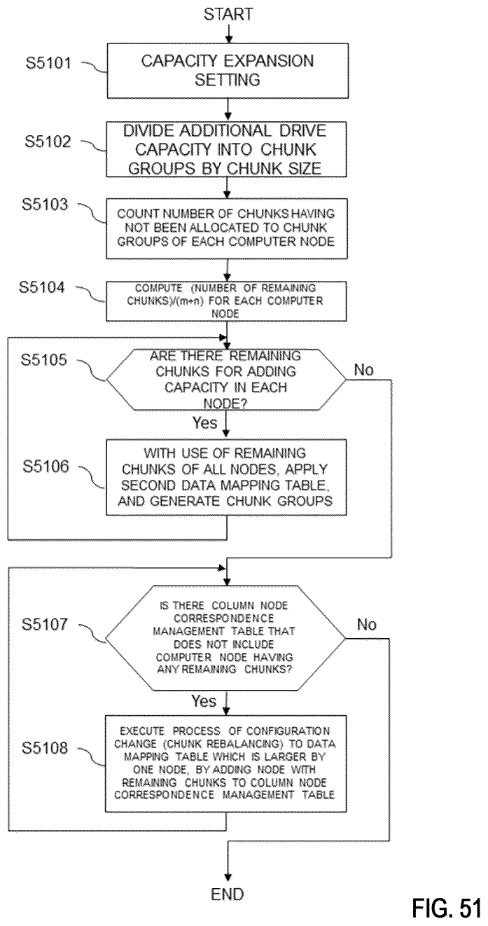

### <FIG. 51: Capacity Expansion Process>

FIG. 51 is a flowchart depicting a capacity expansion processing procedure example according to the second embodiment.

### (Step S5101)

The computer node 110 executes capacity expansion setting according to user operation, and proceeds to Step S5102. The capacity expansion setting is designation of computer nodes 110 and drives 113 to which additional capacity is to be allocated. Hereinbelow, drives 113 added in the capacity expansion setting are referred to as additional drives 113.

### (Step S5102)

The computer node 110 divides the capacity 402 of each additional drive 113 designated at Step S5101, by the chunk size 802 set at Step S2102, and proceeds to Step S5103. By this division, chunks CK (DX) are generated in the additional drives 113. In addition, as a result of this, each entry in the chunk management table 204 in FIG. 8 is generated for the chunks CK (DX) of the newly generated additional drive 113.

In addition, consequently, the capacity 402 allocated to the cells cA1 to cA3, cC1, cD1 to cD3, cE1 to cE3, and cF1 to cF3 represented by dotted rectangles depicted in FIG. 34 is divided by the chunk size 802.

### (Step S5103)

The computer node 110 counts the number of chunks having not been allocated to chunk groups CG of each computer node 110, and proceeds to Step S5104. Specifically, for example, the computer node 110 counts the number of unallocated chunks CK (DA) to CK (DF) that each of the nodes NA to NF has in its drives 113 (including additional drives 113).

### (Step S5104)

The computer node 110 divides, by (m+n), the number of chunks of a node NX for each of the nodes NA to NF.

### (Step S5105)

The computer node 110 determines whether or not there are any chunks remaining (hereinbelow, “remaining chunks”) that can be used to add capacity in each of the nodes NA to NF. Specifically, for example, for each of the nodes NA to NF, the computer node 110 determines whether or not the quotient of a result of the division at Step S5104 is equal to or greater than 1.

In a case where there are any remaining chunks that can be used to add capacity in each of the nodes NA to NF (Step S5105: Yes), the computer node 110 proceeds to Step S5106. On the other hand, in a case where there are no remaining chunks that can be used to add capacity in at least one of the nodes NA to NF (Step S5105: No), the computer node 110 proceeds to Step S5107.

### (Step S5106)

With use of the remaining chunks of all the nodes NA to NF, the computer node 110 applies the second data mapping table 700, generates chunk groups CG #, and returns to Step S5105. Specifically, for example, an entry CNM14 is generated in the column node correspondence management table 207, entries GM14-1 to GM14-6 are generated in the group mapping management table 205, and entries CG14-1 to CG14-6 are generated in the chunk group management table 206. Note that the loop of Yes at Step S5105 and S5106 is repeated until there are no longer any remaining chunks that can be used to add capacity in each of the nodes NA to NF.

### (Step S5107)

The computer node 110 determines whether or not there is an entry that does not include a computer node where there are any remaining chunks in the column node correspondence management table 207. The computer node 110 determines whether or not there is an entry that does not include a node NX having any remaining chunks in the column node correspondence management table 207. Specifically, for example, if the quotient of division of the number of remaining chunks of a node NX by (m+n) is equal to or greater than one, the node NX is a node NX having any remaining chunks. In the second embodiment, a node NX having any remaining chunks is the node NF. The computer node 110 determines whether or not, in the column node correspondence management table 207, there is an entry (the entry CNM1 in FIG. 11 in the second embodiment) that does not include such a node NX having any remaining chunks.

In a case where there is an entry that does not include a computer node NX having any remaining chunks in the column node correspondence management table 207 (Step S5107: Yes), the computer node 110 proceeds to Step S5108. In a case where there is no entry that does not include a computer node NX having any remaining chunks in the column node correspondence management table 207 (Step S5107: No), the capacity expansion process is ended.

### (Step S5108)

The computer node 110 executes a process of a configuration change (chunk rebalancing) to a data mapping table which is larger by one node, by adding the node with the remaining chunks to the column node correspondence management table 207. Specifically, for example, the computer node 110 adds “NF” as a node NX having any remaining chunks as the Col6 node index 1106 of the entry CNM1 in the column node correspondence management table 207. Note that the loop of Yes at Step S5107 and S5108 is repeated until, in the column node correspondence management table 207, there is no longer any entry that does not include a node NX having any remaining chunks.

In this manner, according to the second embodiment, expansion of capacity is realized by a configuration change (chunk rebalancing) of chunk groups CG allocated in the first data mapping table 600 to allocation in the second data mapping table 700.

Note that the present invention is not limited to the embodiments described above, and includes various modification examples and equivalent configurations within the scope of attached claims. For example, the embodiments described above are explained in detail in order to explain the present invention in an easy-to-understand manner, and the present invention is not necessarily limited to the embodiments including all the constituent elements explained. In addition, some of the constituent elements of an embodiment may be replaced with constituent elements of another embodiment. In addition, constituent elements of an embodiment may be added to the constituent elements of another embodiment. In addition, regarding some of the constituent elements of each embodiment, the addition, deletion, or replacement with other constituent elements is possible.

In addition, each constituent element, function, processing section, processing means, or the like described above may be partially or entirely realized by hardware by, for example, designing it with an integrated circuit (IC), or may be realized by software by a processor interpreting and executing a program to realize respective functions.

Information such as a program, a table, or a file to realize each function can be stored on a storage apparatus such as a memory, a hard disk, or an SSD or a recording medium such as an IC card, a secure digital (SD) card, or a digital versatile disc (DVD).

In addition, depicted control lines and information lines are ones that are considered to be necessary for explanation, and all control lines and information lines that are necessary for implementation are not necessarily depicted. It may be considered that, in reality, almost all constituent elements are connected mutually.

What is claimed is:

1. An allocating apparatus comprising:
a processor that executes a program; and
a storage device that stores the program, wherein
the storage device stores a first data mapping table and a second data mapping table,
the first data mapping table is specified such that each chunk in a first chunk group in each first arrangement group including the first chunk group is distributedly arranged in a different computer node, the number of the first arrangement groups being equal to or greater than two and being equal to the number of a plurality of computer nodes minus one,
the second data mapping table is specified such that each chunk in a second chunk group in each second arrangement group including the second chunk group is distributedly arranged in a different computer node, the number of the second arrangement groups being equal to the number of the plurality of computer nodes, and
the processor is configured to execute
a determination process of determining whether or not an imbalance in unallocated capacity among the plurality of computer nodes to which the chunks are not allocated is within a tolerance range,
in a case where the imbalance is determined as being outside the tolerance range in the determination process, a first allocation process of allocating the first chunk groups to unallocated capacity of computer node groups the number of which is equal to the number of the plurality of computer nodes minus one, such that each chunk in the first chunk group in each first arrangement group is distributed to a different computer node, with use of the first data mapping table, and,
in a case where the imbalance is determined as being within the tolerance range in the determination process, a second allocation process of allocating the second chunk groups to unallocated capacity of the plurality of computer nodes such that each chunk in the second chunk group in each second arrangement group is distributed to a different computer node, with use of the second data mapping table.

2. The allocating apparatus according to claim 1, wherein
the processor is configured to determine, in the determination process, whether or not there is an imbalance in unallocated capacity among the plurality of computer nodes,
the processor is configured to, in a case where it is determined in the determination process that there is an imbalance, allocate, in the first allocation process, the first chunk groups to unallocated capacity of the computer node groups such that each chunk in the first chunk group in each first arrangement group is distributed to a different computer node, with use of the first data mapping table, and
the processor is configured to, in a case where it is determined in the determination process that there is no imbalance, allocate, in the second allocation process, the second chunk groups to unallocated capacity of the plurality of computer nodes such that each chunk in the second chunk group in each second arrangement group is distributed to a different computer node, with use of the second data mapping table.

3. The allocating apparatus according to claim 1, wherein
the processor is configured to repeatedly execute the determination process and the first allocation process until the imbalance is determined as being within the tolerance range in the determination process, and
the processor is configured to, in a case where it is determined in the determination process that the imbalance is within the tolerance range as a result of the repeated execution of the determination process and the first allocation process, allocate, in the second allocation process, the second chunk groups to unallocated capacity of the plurality of computer nodes such that each chunk in the second chunk group in each second arrangement group is distributed to a different computer node, with use of the second data mapping table.

4. The allocating apparatus according to claim 1, wherein
the processor is configured to execute a selection process of selecting an allocation-destination computer node of each chunk in the first chunk groups in accordance with a predetermined priority criterion, and
the processor is configured to allocate, in the first allocation process, the first chunk groups to unallocated capacity of the computer node groups on a basis of a result of the selection in the selection process.

5. The allocating apparatus according to claim 4, wherein
the priority criterion is based on largeness of unallocated capacity.

6. The allocating apparatus according to claim 4, wherein
the priority criterion is based on smallness of the number of times of selection in the selection process.

7. The allocating apparatus according to claim 1, wherein
the allocating apparatus is any computer node of the plurality of computer nodes.

8. An allocation method executed by an allocating apparatus including a processor that executes a program and a storage device that stores the program, wherein
the storage device stores a first data mapping table and a second data mapping table,
the first data mapping table is specified such that each chunk in a first chunk group in each first arrangement group including the first chunk group is distributedly arranged in a different computer node, the number of the first arrangement groups being equal to or greater than two and being equal to the number of a plurality of computer nodes minus one,
the second data mapping table is specified such that each chunk in a second chunk group in each second arrangement group including the second chunk group is distributedly arranged in a different computer node, the number of the second arrangement groups being equal to the number of the plurality of computer nodes, and
the processor is configured to execute
a determination process of determining whether or not an imbalance in unallocated capacity among the plurality of computer nodes to which the chunks are not allocated is within a tolerance range,
in a case where the imbalance is determined as being outside the tolerance range in the determination process, a first allocation process of allocating the first chunk groups to unallocated capacity of computer node groups the number of which is equal to the number of the plurality of computer nodes minus one, such that each chunk in the first chunk group in each first arrangement group is distributed to a different computer node, with use of the first data mapping table, and,
in a case where the imbalance is determined as being within the tolerance range in the determination process, a second allocation process of allocating the second chunk groups to unallocated capacity of the plurality of computer nodes such that each chunk in the second chunk group in each second arrangement group is distributed to a different computer node, with use of the second data mapping table.
